(19) United States
(12) Patent Application Publication
(10) Pub. No.: US 2016/0021581 A1
(43) Pub. Date: Jan. 21, 2016

(54) PACKET DATA CONVERGENCE PROTOCOL (PDCP) PLACEMENT

(71) Applicant: INTERDIGITAL PATENT HOLDINGS, INC., Wilmington, DE (US)

(72) Inventors: Yugeswar Deenoo, King of Prussia, PA (US); Samian Kaur, Plymouth Meeting, PA (US); Ravikumar V. Pragada, Collegeville, PA (US)

(73) Assignee: INTERDIGITAL PATENT HOLDINGS, INC., Wilmington, DE (US)

(21) Appl. No.: 14/761,619

(22) PCT Filed: Jan. 17, 2013
(86) PCT No.: PCT/US2014/012067

§ 371 Date: Jul. 16, 2015

Related U.S. Application Data
(60) Provisional application No. 61/753,867, filed on Jan. 17, 2013.
(60) Provisional application No. 61/811,233, filed on Apr. 12, 2013.

(51) Int. Cl. H04W 36/00; H04W 48/16; H04W 16/26

(52) U.S. Cl. CPC H04W 36/0055; H04W 16/26; H04W 48/16

(57) ABSTRACT

Embodiments contemplate Small Cell Enhancements such as PDCP Placement and impact on control and data plane procedures. Embodiments contemplate small-cell enhancements such as they relate to dual-connectivity scenarios. Different architecture models and their impact on procedural aspects are contemplated. Different RAN, protocol stack and radio bearer (RB) architectures along with their implications are described. These architectures may be applicable to one or more of control plane that may terminate at the macro. Also, a small-cell that may be capable of supporting RLC modes and/or that may be capable of supporting MAC functionality is contemplated. A small-cell may be capable of supporting bidirectional physical channels. Also, there could be an aggregation point (either at the macro eNB or at a different physical or logical RAN node) for S1-U interface termination. The Small Cell eNB (SCeNB) could be in control of the Macro eNB.

### CROSS-REFERENCE TO RELATED APPLICATIONS

This application claims the benefit of U.S. Provisional Patent Application No. 61/753,867, titled “Packet Data Convergence Protocol (PDCP) Placement”, filed on Jan. 17, 2013; and U.S. Provisional Patent Application No. 61/811,233, titled “Packet Data Convergence Protocol (PDCP) Placement”, filed Apr. 12, 2013, the contents of both applications hereby incorporated by reference as if fully set-forth herein in their respective entirety, for all purposes.

### BACKGROUND

An increase in the demand for data has shown itself to be relatively predictable. This predicable demand for data, and a corresponding increase in data delivery capacity, has been observed for at least the last 50 years and has come to be known as Cooper's Law—which states that the total capacity will double about every 30 months.

### SUMMARY

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments contemplate Small Cell Enhancements such as PDCP Placement and impact on control and data plane procedures

Embodiments contemplate small-cell enhancements such as they relate to dual-connectivity scenarios. Different architecture models and their impacts on procedural aspects are contemplated. Different RAN, protocol stack and radio bearer (RB) architectures along with their implications are described. These architectures may be applicable:

Control plane may terminate at the macro, and S1-C terminates at the macro

Small-cell may be capable of supporting all RLC modes

Small-cell may be capable of supporting MAC functionality

Small-cell may be capable of supporting bidirectional physical channels

There could be an aggregation point (either at the macro eNB or at a different physical or logical RAN node) for S1-U interface termination; and/or

The Small Cell eNB (SCeNB) could be in complete control of the Macro eNB (for example, master-slave relationship).

Embodiments contemplate that a first wireless transmit/receive unit (WTRU) may be in communication with a network. The first WTRU may comprise a processor. The processor may be configured to receive a second radio resource control (RRC) configuration that may correspond to a second WTRU. The second RRC configuration may be a replacement to a previously received first RRC configuration. The processor may be configured to receive an uplink (UL) indication resource that may correspond to the second WTRU. The second WTRU may be in communication with the network. The processor may be configured to configure a medium access control (MAC) layer with the second RRC configuration. The MAC layer may correspond to the second WTRU. The processor may be configured to initiate the transmission of a first indication to the second WTRU, perhaps using the UL indication resource. The first indication may indicate to the second WTRU to activate a configuration corresponding to the second RRC configuration.

Embodiments contemplate a first wireless transmit/receive unit (WTRU) that may be in communication with a communication network. The first WTRU may comprise a processor. The processor may be configured to receive a first configuration for the first WTRU. The first configuration may correspond to a second WTRU. The processor may be configured to receive an indication from the second WTRU. The indication may cause the first WTRU to activate the first configuration. The processor may be configured to activate the first configuration, for example upon receipt of the indication.

Embodiments contemplate a wireless transmit/receive entity (WTRU). The WTRU may be in communication with a network and one or more radio link control (RLC) entities. The WTRU may comprise a processor. The processor may be configured to receive a first packet of one or more packets from a first radio link control (RLC) entity of the one or more (RLC) entities. The processor may be configured to determine that the first packet may be an out-of-sequence packet. The processor may be configured to start a timer, perhaps upon determining that the first packet may be an out-of-sequence packet. The processor may be configured to determine at least one missing sequence number. The processor may be configured to receive a second packet of the one or more packets from a second RLC entity of the one or more RLC entities. And the process may be configured to perform a packet sequence status check, for example perhaps upon receipt of the second packet.

Embodiments contemplate a first wireless transmit/receive unit (WTRU). The first WTRU may be in communication with a network. The first WTRU may comprise a processor. The processor may be configured to receive a handover request from a second WTRU. The processor may be configured to configure at least a third WTRU with a first random access channel (RACH) configuration that may correspond to a fourth WTRU. The first RACH configuration may cause the at least third WTRU to perform a RACH listen procedure. The processor may be configured to send to the second WTRU a handover acknowledge message. The processor may be configured to obtain results of the RACH listen procedure. The results may include a timing advance, an uplink (UL) signal level, and a RACH preamble information from the at least third WTRU. The processor may be configured to identify the at least third WTRU as a small cell candidate, perhaps based on the results of the RACH listen procedure. The processor may be configured to configure the at least third WTRU to service the fourth WTRU as a small cell.

Embodiments contemplate a first wireless transmit/receive unit (WTRU). The first WTRU may be in communication with a network. The first WTRU may comprise a processor. The processor may be configured to receive a first random access channel (RACH) configuration that may correspond to a second WTRU. The first RACH configuration may cause the first WTRU to perform a RACH listen procedure. The processor may be configured to receive a second RACH configuration that may be applicable to a macro enhanced Node-B (MeNB) device and a small cell enhanced Node-B (SCeNB) device. The processor may be configured to determine a timing advance, perhaps based on the RACH listen procedure and the second RACH configuration. The processor may be configured to receive a handover request from a third WTRU.

Embodiments contemplate a first wireless transmit/receive unit (WTRU). the first WTRU may be in communication with a network. The first WTRU may comprise a processor. The processor may be configured to trigger a second WTRU to measure at least a third WTRU. The at least third WTRU may be associated with a fourth WTRU. The processor may be configured to receive measurement results for the at least third WTRU. The processor may be configured to provide to the fourth WTRU a first indication that the at least third WTRU was measured. The processor may be configured to provide to the fourth WTRU a set of bearers mapped to the at least third WTRU; and receive from the fourth WTRU a second indication to retain one or more bearers of the set of bearers on a small cell layer and one or more bearers of the set of bearers on a macro layer. The one or more bearers on the macro layer may be moved from at least one of the first WTRU or a fifth WTRU, perhaps after a handover.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of another example radio access network and an example core network that may be used within the communications system illustrated in FIG. 1A;

FIG. 1E is a system diagram of another example radio access network and an example core network that may be used within the communications system illustrated in FIG. 1A;

FIG. 1F illustrates an example block diagram implementing PDCP layer at the Small-cell consistent with embodiments;

FIG. 2 and FIG. 2A illustrate an example L2 structure for DL (Separate DRB model) consistent with embodiments;

FIG. 3 illustrates an example L2 structure for UL (Separate DRB model—PDCP in the Macro consistent with embodiments;

FIG. 4 and FIG. 4A illustrate an example L2 structure for DL (Single DRB model—PDCP in the Macro) consistent with embodiments;

FIG. 5 illustrates an example L2 structure for DL (Single DRB model) consistent with embodiments;

FIG. 6 illustrates an example call flow for a PDCP in the macro—separate RB consistent with embodiments;

FIG. 7 and FIG. 7A illustrate an example signal flow of a reconfiguration of the macro cell layer, consistent with embodiments;

FIG. 8 illustrates an example PDCP reordering sequence, consistent with embodiments;

FIG. 9 illustrates a block diagram of an example Security Key Generation consistent with embodiments;

FIG. 10 illustrates an example technique for the communication of an updated RRC configuration, consistent with embodiments;

FIG. 11 illustrates an example Small-cell shared by Multiple operators consistent with embodiments; and

FIG. 12 illustrates an example signal flow of a Combined RACH technique consistent with embodiments.

### DETAILED DESCRIPTION OF ILLUSTRATIVE EMBODIMENTS

A detailed description of illustrative embodiments will now be described with reference to the various Figures. Although this description provides a detailed example of possible implementations, it should be noted that the details are intended to be examples and in no way limit the scope of the application. As used herein, the articles “a” and “an”, absent further qualification or characterization, may be understood to mean “one or more” or “at least one”, for example.

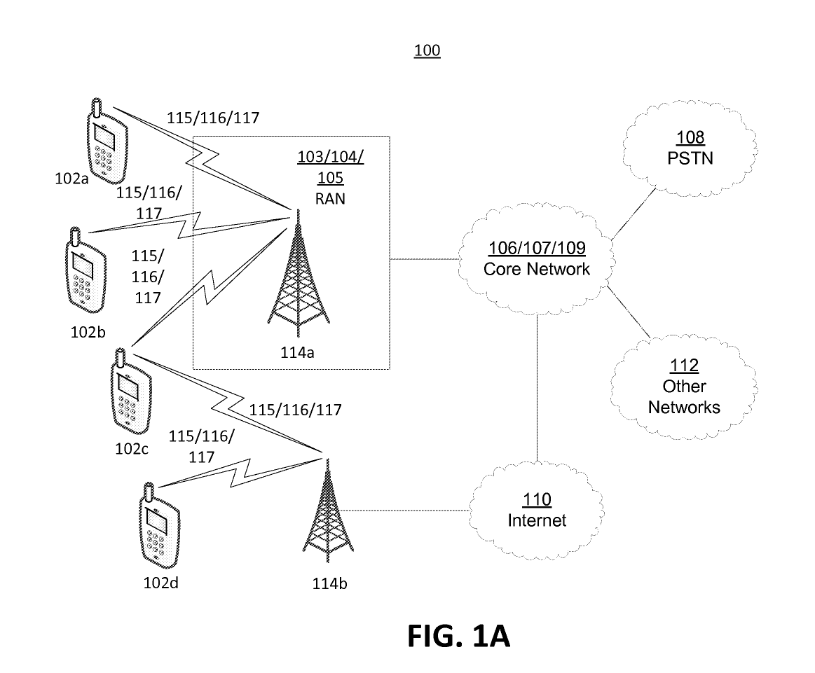

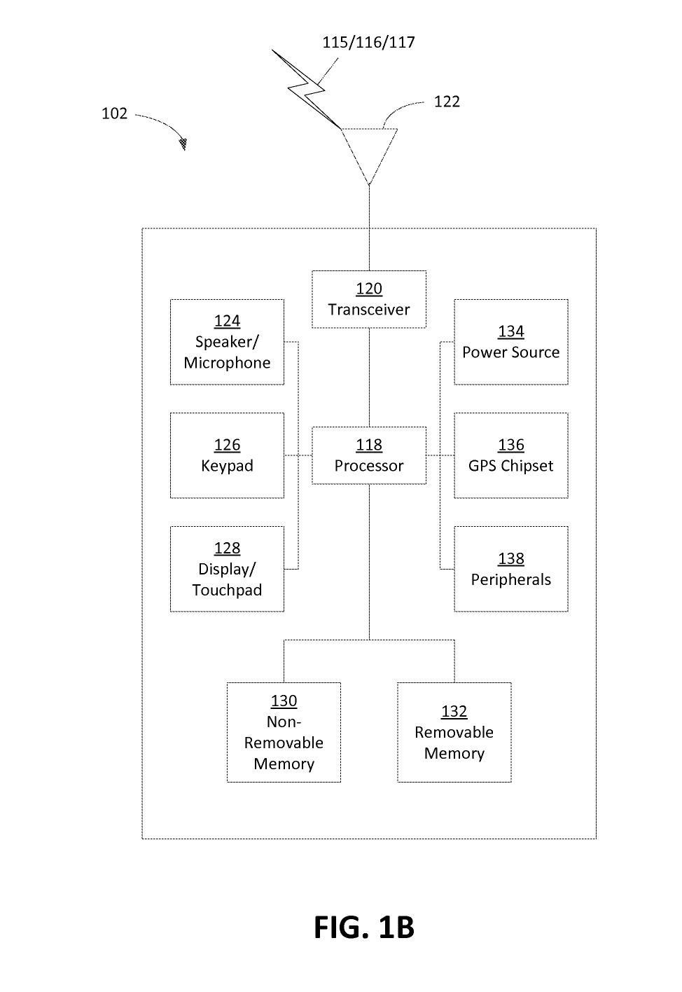

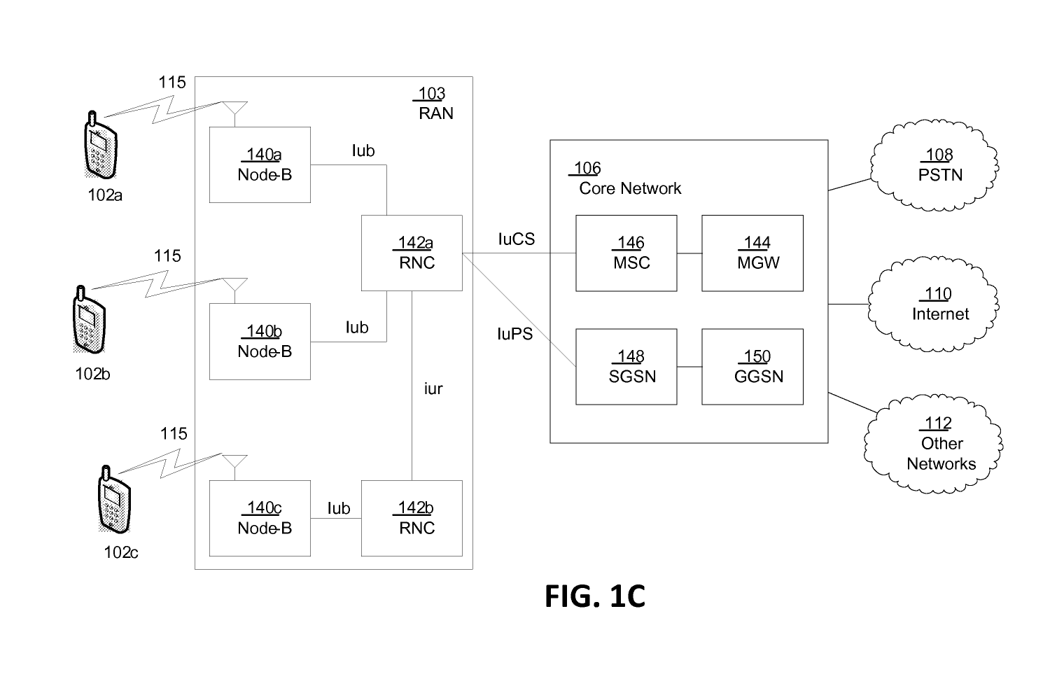

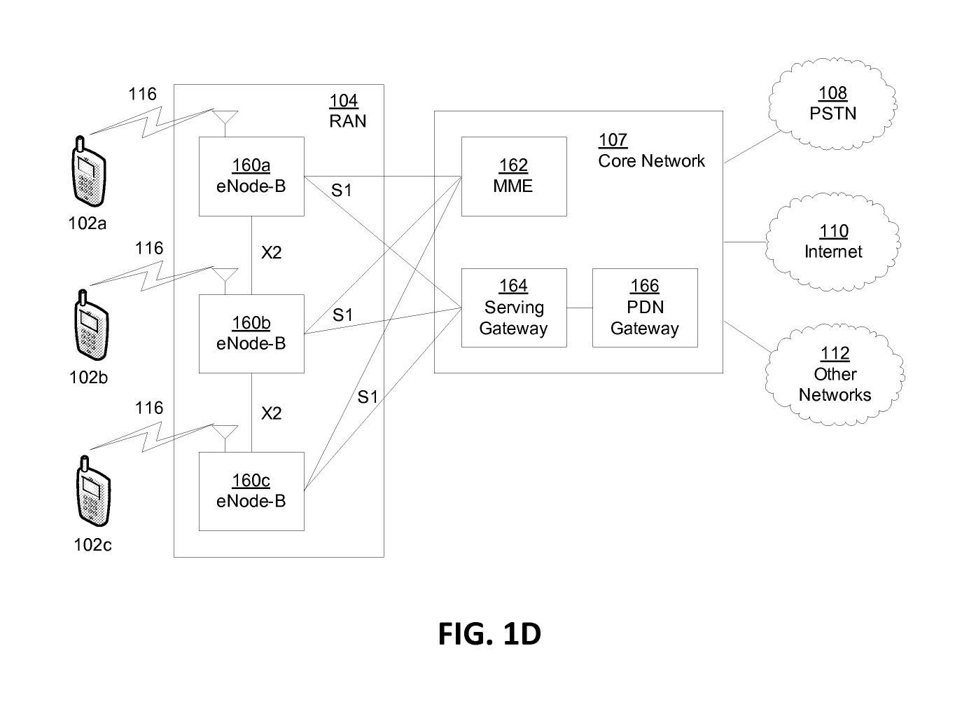

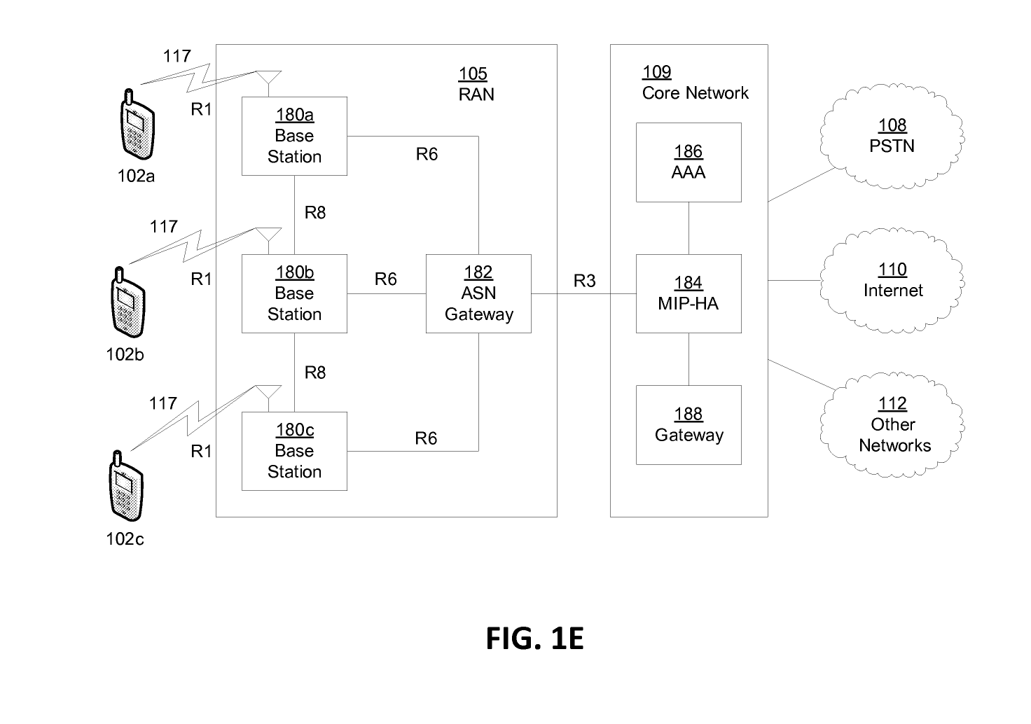

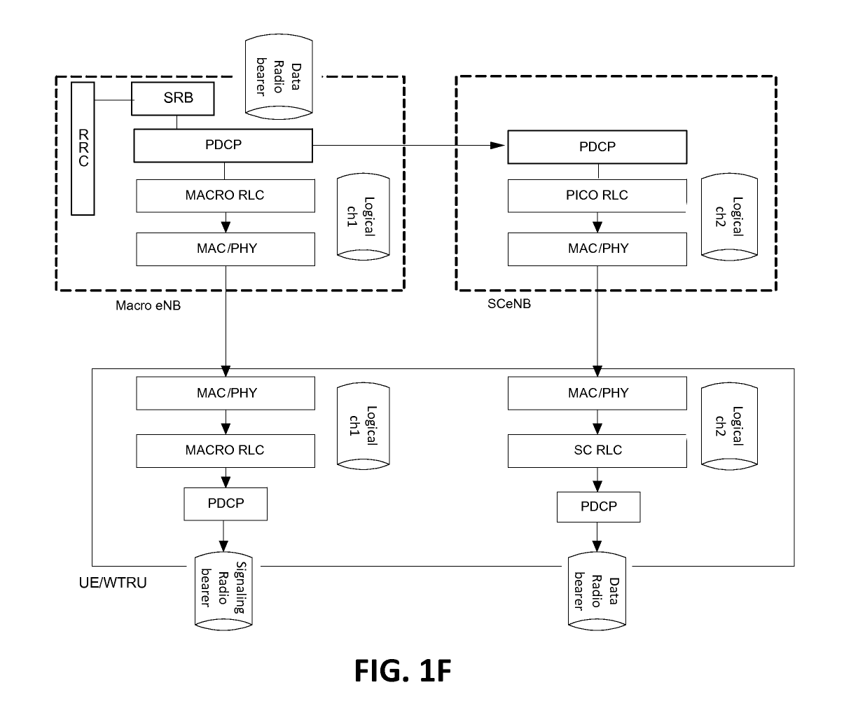

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

One or more or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include one or more or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks. As used herein, in one or more embodiments, and/or in the corresponding figures, a user equipment (UE) may also be referred to as a wireless transmit/receive unit (WTRU).

Embodiments recognize that more recently, demand for data, and the corresponding increase in data delivery capacity has been closer to doubling every year or two. There may be many incremental technology advances taking place in air interfaces and in networks that may provide meaningful gains, but for the predicted demand for mobile data a decade from now, perhaps two synergetic strategies may emerge as the technologies capable of delivering this huge demand.

Embodiments recognize that one such strategy may be the use of smaller and smaller cells. “Small cells” may imply an increased spatial reuse of the same spectrum and may be a way to achieve greater capacity. 3GPP entities may recognize using low-power nodes as one of the ways to cope with mobile traffic explosion, perhaps especially for hotspot deployments in indoor and/or outdoor scenarios. A low-power node may generally refer to a node whose transmission (Tx) power may be lower than a macro node and/or base station (BS) classes, for example Pico and Femto eNB may be both applicable.

Embodiments recognize the use of additional spectrum, for example 3.5 GHz and higher frequencies. There may also be potential for large bandwidth channels to be available in high frequency carriers. There may be a synergetic effect to be exploited at higher frequencies that may not have been possible in lower-frequencies (for example, below 2 GHz), namely there may be a potential of much greater spatial reuse. Perhaps in order to close the link budget for mmWs, highly directional antennas may be useful and are perhaps becoming practical (e.g. Wireless HD devices). The transmissions may be highly contained in the sense that transmitted energy may be concentrated on the intended receiver (e.g. increasing signal strength) while radiating little in other directions making it much less likely that the transmission may cause much interference for unintended receivers. This may be useful when it comes to addressing inter-cell interference in small cells. Since there may be naturally a low probability of interference in the first place, there may be a lower requirement for complicated inter-cell interference mitigations techniques.

High frequency carriers (e.g., in the mmW spectrum) may provide potentially large amounts of spectrum that could be made available, and perhaps with affordable terms. The 60 GHz unlicensed spectrum alone may be about 7 GHz (perhaps depending on the country) and there may be potentially much more that could become available either as licensed, lightly licensed, and/or unlicensed spectrum.

Embodiments recognize that the mmW Hotspot (mmH) architecture may be influenced by the usefulness for small cells and the use of mmW carrier frequencies. These two influences may be compatible and perhaps even complimentary. The mmH architecture may include new small mmW base stations that may be overlaid on a cellular network. The mmW base stations may be denser than the traditional macro eNBs and may employ self-backhaul that may use a mmW MESH network to the macro eNB (or other wired/wireless aggregation point). Phased array antennas may be useful to close the links due to limited available Tx power and may provide a low interference environment, and also may enable a flexible backhaul architecture. These phased array antennas can also create narrow steerable beams that may provide backhaul links perhaps rather than additionally deploying a wired backhaul. Because the beams may be narrow and/or steerable, they may enable an adaptable MESH backhaul with pseudo-wired low interference connections between backhaul links. They may also enable nodes to self-configure and/or join the MESH as they may be installed, perhaps since the peer-to-peer (P2P) links may not be pre-planned as may be the case with fixed beam mmW links.

Embodiments contemplate a usefulness for dual connectivity, where UE (or WTRU) may be connected to both the macro and the small-cell layer simultaneously. The small-cell layer could be made up of several deployment scenarios, including but not limited to one or more of:
Carrier aggregation on the macro layer with bands X and Y, and band X on the small cell layer (and in some embodiments perhaps only band X on the small cell layer);
Small cells supporting carrier aggregation bands that may be co-channel with the macro layer; and/or
Small cells supporting carrier aggregation bands that may not be co-channel with the macro layer.

Embodiments recognize that existing RAN and/or protocol stack architectures may not apply for dual-connectivity scenarios when a user may be connected to both the macro-layer and the small-cell layer. New (heretofore undefined for such purposes) RAN and/or protocol stack architectures and/or corresponding control and data plane procedures may be useful to address the scenarios and challenges that dual-connectivity may bring.

One or more embodiments contemplate small-cell enhancements with dual-connectivity in which small-cell deployments have macro coverage. The technology contemplated herein may also be applicable to one or more, or all, existing and as well as future cellular bands, with (perhaps in some embodiments) a focus on higher frequency bands, e.g., the 3.5 GHz band, to utilize the more available spectrum and/or wider bandwidth. These may include mmW frequencies and/or techniques described herein that may also be applicable to integrating a non-standalone underlay layer, with a macro overlay system, such that the macro layer may provide the required control framework and the underlay layer may provide relatively “large data pipes” for carrying high throughput data.

The term dual-connectivity may be also meant to cover scenarios where the user equipment ((UE) or wireless transmit/receive unit (WTRU)) may be connected to the macro-layer and one or more small-cells simultaneously (e.g. UE might be actively receiving data from the cells it may be connected to).

One or more embodiments contemplate different RAN, protocol stack and/or radio bearer (RB) architectures along with their implications. These architectures may be applicable, but not limited to, one or more of the following scenarios:
Control plane terminates at the macro, and S1-C terminates at the macro

Small-cell is capable of supporting all RLC modes

Small-cell is capable of supporting MAC functionality

Small-cell is capable of supporting bidirectional physical channels

There could be an aggregation point (either at the macro eNB or at a different physical or logical RAN node) for S1-U interface termination, and/or

The Small Cell eNB (SCeNB) could be in partial or complete control of the Macro eNB (for ex., master-slave relationship)

One or more embodiments contemplate Packet Data Convergence Protocol in one or more small cells. In this architecture, the PDCP entity for one or more, or each, radio bearer may be in the small cell node. The security could be common using the same (shared) key or separate security keys. In some embodiments, perhaps to perform reconfiguration and data transfer from one small cell node to another, the context transfer between source and target SCeNBs may need to be performed. FIG. 1F illustrates an example block diagram of PDCP layer at a small-cell.

In some embodiments, a user plane aggregation point may be part of the architecture. In such a scenario, S1-U may terminate at the aggregation point. In some embodiments, an Aggregation point/Gateway may or may not be co-located with macro eNB.

Embodiments contemplate one or more mobility aspects, such as one or more of:
Lossless handover may find useful a new user-plane interface between the small cell nodes (X3);
S1-U may terminate at the small cell or the macro; and/or
Local forwarding (between Small cell nodes) may be useful for lossless handover.

One or more embodiments contemplate PDCP in a macro cell. In some embodiments, the PDCP entity may be terminated in the macro-cell. This may leave RLC, MAC and/or PHY in small cell (or in some embodiments perhaps only those entities or layers). Embodiments contemplate a thin control layer in small cell (at least for UE context management). Having PDCP in macro may include, but not limited to minimal context transfer, reduced interruption time during handover, no security key exchange needed between macro and small cell, no data forwarding between small cells.

With PDCP in the macro cell, embodiments contemplate at least two alternatives, single RB model or separate RB model. These alternatives are explained herein. The following are some of the aspects of this protocol-stack architecture:

Security—one or more, or all aspects of security including ciphering and/or integrity protection may be handled in the Macro-cell. SCeNB to SCeNB handovers may therefore be treated as intra Macro-eNB handovers, so RoHC context transfer may be supported.

S1-U may terminate at the macro

PDCP data may be buffered at the Macro-eNB

Local forwarding may not be required for lossless handover

PDCP re-ordering in UE is during re-establishment (or in some embodiments perhaps only during re-establishment), so local forwarding of data may not be required; and/or

PDCP status report may be generated when UE handover is complete.

One or more embodiments contemplate a Separate Data Radio Bearer (DRB) model. In a separate DRB model, there may be one to one mapping (or in some embodiments perhaps there may always be one to one mapping) between PDCP and RLC entity (e.g. similar to 3GPP baseline). See figures below for both UL and DL data plane aspects. In some embodiments, a PDCP entity that may be created for DRBs in small cell may persist during the handovers between small cells.

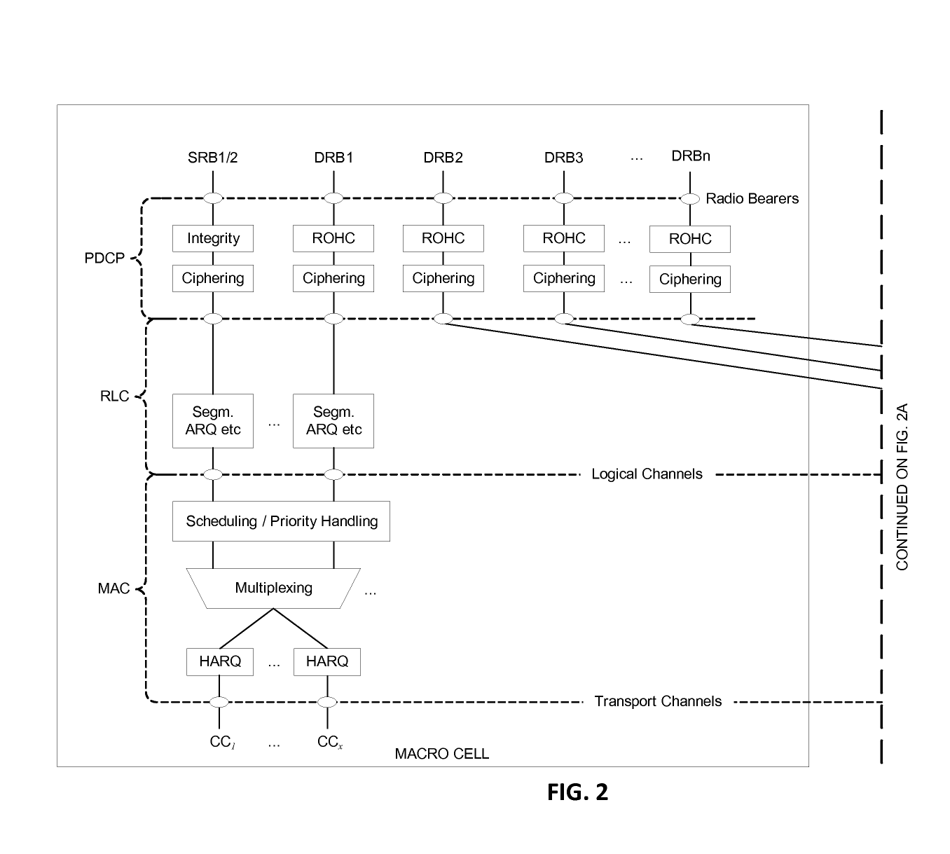

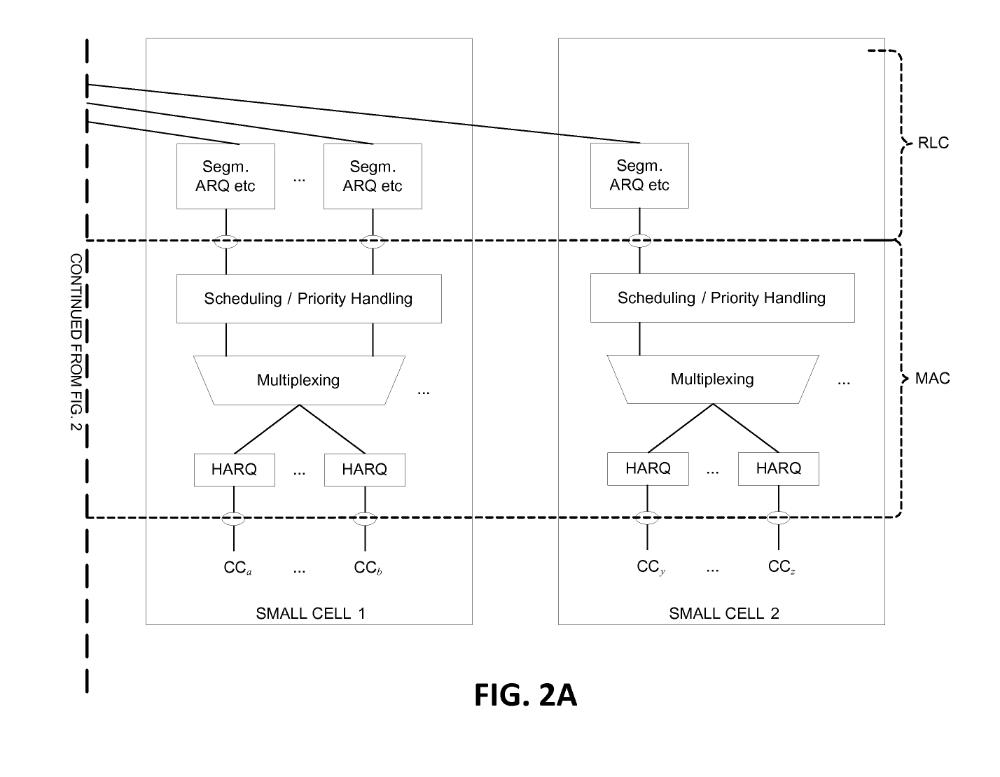

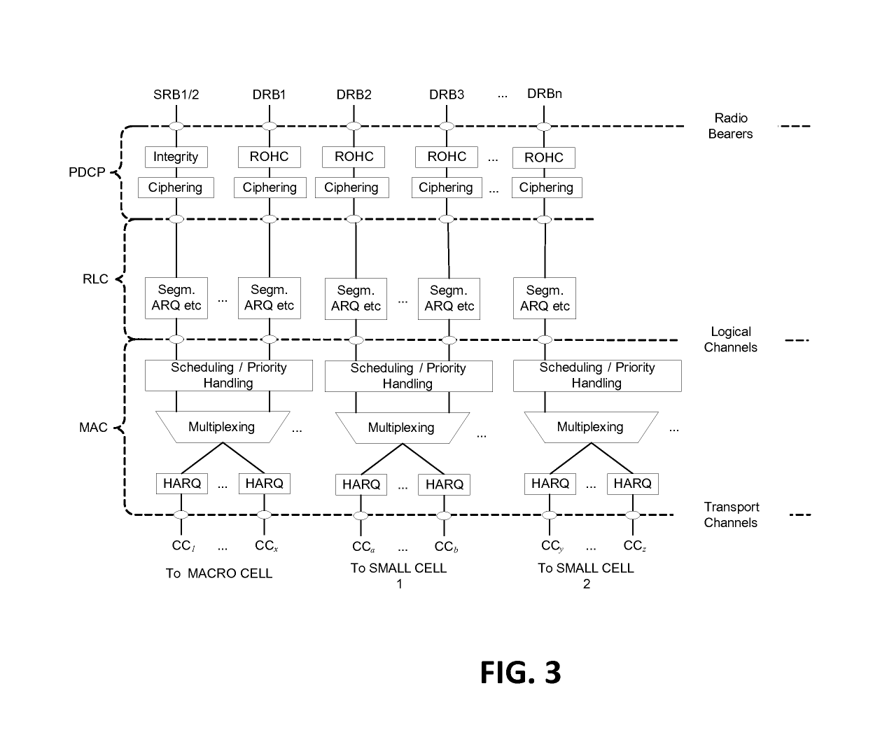

In some embodiments, one or more, or both, PDCP and RLC may buffer the packets. In some embodiments, during handover, local forwarding may be enabled to allow RLC in the source. The source SCeNB may forward RLC SDUs to the target SCeNB. These may include SDUs that may not be transmitted at all and also those SDUs that may have been transmitted but may not have been ACKed. In some embodiments, the PDCP status report may go to macro and not the SCeNB. Local forwarding may be affected by duplicate PDUs that may be ACKed in status report, but may still be forwarded locally between the source and the target SCeNBs, for example. FIG. 2 and FIG. 2A illustrate an example L2 structure for downlink (DL) in a separate DRB embodiment. FIG. 3 illustrates an example L2 structure for uplink (UL), for example a separate DRB model—where PDCP may be in the Macro.

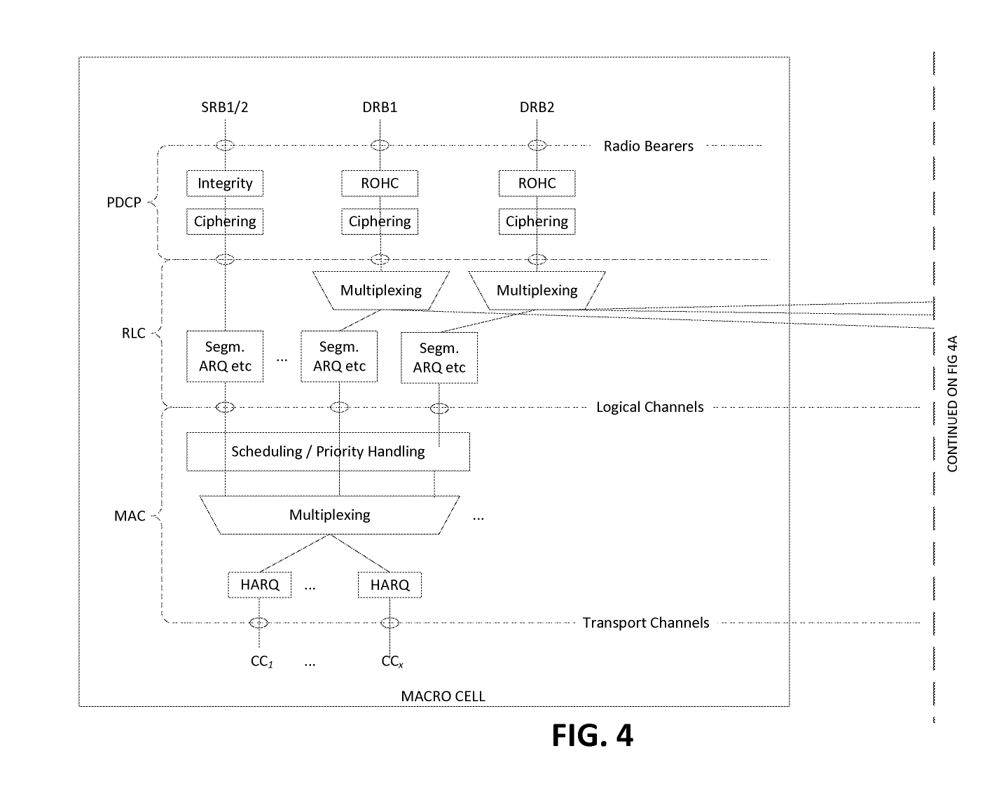

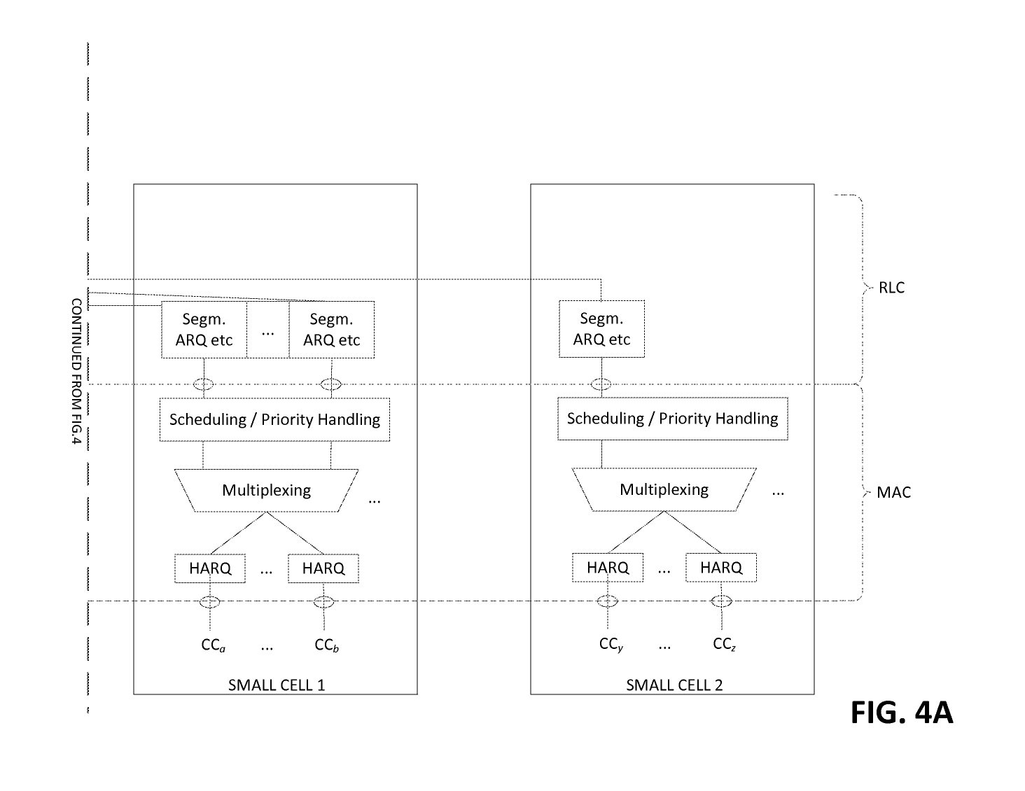

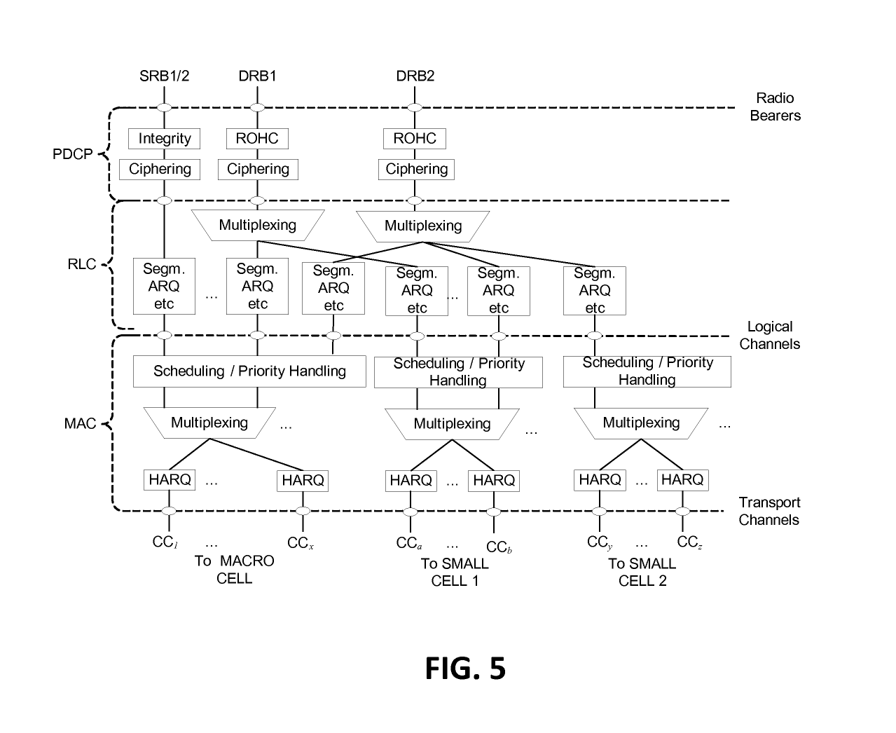

One or more embodiments contemplate a single DRB model. A single DRB may be split between a macro and a small cell. In some embodiments, a PDCP in a macro can have two underlying corresponding RLC protocol set entities, one set in macro and/or another set in the small cell, for example. FIG. 4 and FIG. 4A illustrate an example structure for DL, for example a single DRB model, where the PDCP may be in the Macro. FIG. 5 illustrates an example L2 structure for DL, such as a single DRB model.

Embodiments contemplate one or more aspects of reconfiguration of traffic from one small cell node to another small cell node in the context of the architectures described herein. In embodiments that may include a separate DRB

One or more techniques are contemplated for new (heretofore undefined for such purposes) handover signaling, RACH, PDCP re-ordering, and/or security for reconfiguration of small cells.

RACH

PDCP re-establishment and re-ordering procedures

Security

X2 signaling

In scenarios where small-cell layer infrastructure may be deployed by a 3rd party (such as Boingo) and shared among multiple mobile network operators, RAN architecture and/or procedural impacts are described herein. In addition, in dense urban deployments, a particular small-cell may be shared by multiple macro eNBs. This may also be applicable to mmW hotspot scenarios, where small-cell boundaries may not be as clearly defined as those in lower frequencies and/or may be more limited by the reachability of the narrow beams that may be used for mmW operation.

One or more embodiments contemplate a single DRB. In the baseline 3GPP procedures for PDCP, a PDCP entity may advance its re-ordering window one or more, or every, time a PDU may be successfully received. An exception (in some embodiments perhaps an only exception) may be during Handover when the out of order PDCP SDUs due to re-establishment may be buffered. But perhaps as soon as handover may be complete, UE may expect packets to be in order (first missing PDU) else the packets may be lost.

In such DRB embodiments, it may be useful for a PDCP to receive one or more reordering procedures perhaps even in a normal data transfer case and may not be limited (perhaps may not be only limited) to the handover time-period. This may be due to the fact that there may be implicit Multi-RLC protocol (e.g. one set of corresponding RLC entities at the Macro and/or another set at the SCeNB), so even in a normal case the PDCP PDUs may arrive out of order. Some embodiments contemplate that it may also be useful to factor a PDCP discard timer on the transmitter, for example.

One or more embodiments contemplate a small cell configuration. The small cell configuration from RRC signaling point of view may be made of one or more of at least three parts:

SCellToAddModList which may include but not be limited to sCellIndex, phycellid, eutra frequency, physicalConfigDedicatedSCell, mac mainconfig;

DRB-ToAddModList; and/or

SCeNB Id.

In some embodiments, the actual content of DRB-ToAddModList may depend on the small cell architecture:

If PDCP may be present in the small cell then, DRB-ToAddModList may include but not limited to eps-BearerIdentity, drb-Identity, pdcp-Config, rlc-Config, logicalChannelIdentity, logicalChannelConfig; and/or

If PDCP layer may not be present in the small cell then DRB-ToAddModList may include eps-BearerIdentity, drb-Identity, rlc-Config, logicalChannelIdentity, and/or logicalChannelConfig

Addition of DRB-ToAddModList may be different from the baseline signaling, as currently the SCell is transparent to the radio bearer. But in case of small cell eNB, in addition to SCell configuration, the radio bearer configuration may also be signaled. In case of small cell addition, both SCell and radio bearer configurations may be present. In case of Scell addition in the small cell layer, SCellToAddModlist may be present (and in some embodiments perhaps may be the only present). In case of radio bearer reconfiguration in the small cell layer, DRB-ToAddModList may be present (and in some embodiments perhaps may be the only present). By separating out the SCell and DRB configuration, it may be possible to independently add and/or remove component carriers and/or radio bearers in the small cell layer.

In one or more embodiments, the mapping of SCell and DRB configuration to the small cell eNB may be provided by the addition of group/node index to the RRC configuration (e.g., SCeNB Id). The group/node index may uniquely identify the particular small cell eNB. A UE may use this index to differentiate/map the carriers and/or bearers to small cell eNB. In some embodiments, the component carriers and/or bearers on the macro eNB may be identified by the absence of a group/node index and/or by reserving a special value (e.g. “0”) for a group index to refer to macro eNB.

It may be also possible to relocate radio bearers from macro to small cell by providing the macro radio bearer info in the DRB-ToAddModList of the small cell layer configuration with corresponding group/node index of the small cell and removing the corresponding radio bearer from macro configuration using DRB-ToReleaseList with the corresponding macro implicitly and/or by using group/node index “0”. In some embodiments, radio bearers can be relocated from small cell to the macro. For the bearers being relocated, eps-bearerid and/or (in some embodiments) the drb-id may remain unchanged after the relocation operation.

In case of an Scell release procedure the Scell may be signaled using SCellToReleaseList and/or the group/node index. Similarly the radio bearer release may be signaled using drb-ToReleaseList and/or the group/node index. To remove the whole small cell configuration (e.g. small cell deletion), Group/index toreleaseList may be added. This may carry the list of small cell eNBs identified by a group/node index to be released. This may release one or more, or all, the SCell and/or the radio bearers configured for the corresponding small cell.

One or more embodiments contemplate reconfiguration. One or more embodiments also contemplate reconfiguration of the small cell layer. The macro-eNB may control the handover procedures for UEs in RRC-CONNECTED mode, perhaps assisted by measurement reports from the UE. Separate measurement configurations may be applied for macro layer and small cell layers. The following handover scenarios are contemplated herein:
a) MeNB1=>MeNB1+SCeNB1 (SCeNB addition)
   In this scenario, a new small-cell may be added to the UE configuration in addition to the existing Macro-cell that to which UE may already be connected.
b) MeNB1+SCeNB1=>MeNB1+SCeNB2 (handover in small cell layer)
   In this scenario, UE may still be attached to the same macro-cell that it may be connected to, but may move from source small-cell (SCeNB1) to target small-cell (SCeNB2); and/or
c) MeNB1+SCeNB1=>MeNB1 (SCeNB deletion)
   In this scenario, the small-cell may be removed/deleted from the UE configuration and the UE may remain on the Macro-cell that to which the UE may already be connected.

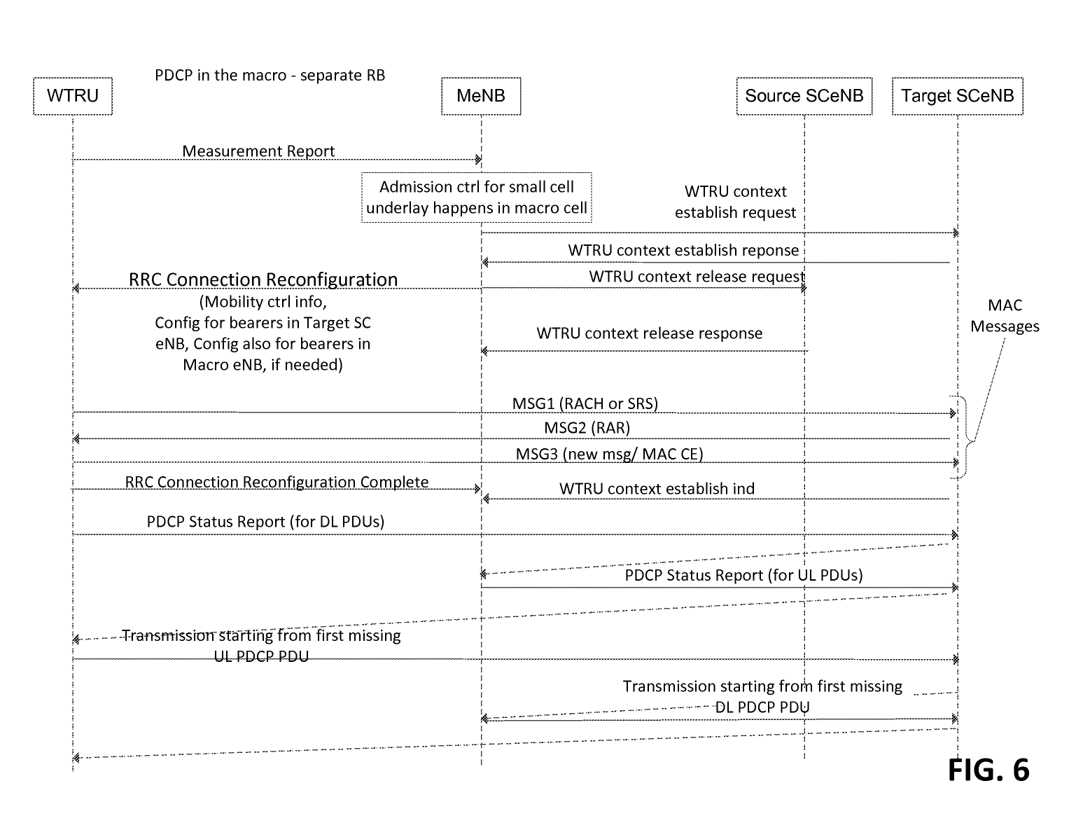

FIG. 6 depicts an example call flow for a handover in a small cell layer with the macro remaining unchanged after handover, specifically covering scenario (b) above, but also at least implicitly scenarios (a) and (c) as well.

Referring to FIG. 6, the Macro eNB may configure the measurement parameters/events/triggers for the UE in an RRC CONNECTED mode. The UE may send the measurement report when the configured reporting criterion is satisfied. In this example, it could be an event representing the serving SCeNB RSRP/RSRQ level below the configured threshold and/or the target SCeNB RSRSP/RSRQ level above the configured threshold.

Embodiments contemplate that different outcomes may be possible perhaps depending on the scenario. In some embodiments the macro eNB may perform the one or more of the following:
a) the admission control for the target SCeNB may happen in the Macro eNB, for example perhaps if the target SCeNB might not be shared among other macro eNB and/or perhaps if the target SCeNB might not support Rel8 operation;
b) in some embodiments, the macro eNB may do a first level of admission control for SCeNB2 and/or the second level of admission control happens in the SCeNB; and/or
c) in some embodiments the macro eNB can prepare multiple SCeNBs for the same UE.

In some embodiments, perhaps if the macro can accept the bearers active in the source SCeNB, then the scenario may become a small cell deletion procedure. In this case, the RRC reconfiguration message may include DRBtoRelease list to release the DRBs in the small cells (e.g. indicated by a corresponding group/node index) and may include DRBAddModList for the macro layer to include the bearers relocated to the macro eNB. So the scenario may be macro+ small cell->macro (also called relocation of small cell bearers to macro).

It may also happen that macro eNB can prepare multiple SCeNB for the same UE for small cell addition procedure. In this case the RRC reconfiguration message may include the DRB configurations for one or more SCeNB in the DRBAddModList with corresponding group/node index.

Some embodiments contemplate a small cell handover procedure where the bearers may be relocated from the source SCeNB to target SCeNB. In this case RRC connection reconfiguration may include the DRBtoReleaseList with the source SCeNB group/node index and/or the DRBAddModList with target SCeNB group/node index.

In some embodiments, a same DRB can be split between macro and SCeNB. This may be applicable to the scenario where a PDCP may be in the macro cell. In this case, the macro may provide the same epsbearer-id, drb-id and potentially different RLC and/or logical channel configuration for the small cell configuration. The list of SCell component carriers included in the small cell configuration may depend on the measurement report received from the UE. SCeNB2 may then admit the UE and may send an acknowledgement to macro eNB.

The MeNB may then prepare one or more of the target SCeNB by providing the UE context information which can include among others, UE capability, UE AMBR, Subscriber profile ID, RBs to setup and/or their QoS parameters etc. The SCeNB2 may then admit the UE and may send acknowledgement to macro eNB.

Macro eNB may deactivate one or more source SCeNB by sending a UE context release request. The Macro may also send an RRC Connection reconfiguration to the UE with macro and/or the small cell configuration.

For the case when PDCP may be present in the Macro, a UE context release on the source SCeNB may trigger RLC to send the queued UL RLC SDUs to the corresponding PDCP entity in the macro. PDCP in macro buffers these PDCP PDUs until the next in sequence PDU may be received from the UE (via the target SCeNB).

For the case when PDCP may be present in the small cell, the UE context release on the source SCeNB may trigger RLC to send the queued UL RLC SDU to the PDCP entity in the target SCeNB.

After receiving a handover command, the UE may trigger re-establishment of the PDCP and small cell RLC entities. The UE may then synchronize to the target cell (e.g. if not done already) and then perform RACH on the target cell. A RACH procedure may be performed as specified herein.

In case of s single DRB split, the UE and macro may exchange a PDCP status report over the macro link, when the handover procedure is going in the small cell layer. The trigger to send the status report on the macro layer may be the reception of the RRC Connection reconfiguration message with the release of DRB on the small cell layer. Also the data transmission on the bearers split between macro and small cell may continue on the macro layer when the small cell handover may be ongoing.

The same principles may apply when the bearers may be split between multiple SCeNBs and some of the SCeNBs may be reconfigured.

In case of contention based random access (e.g. if no dedicated preamble available), a conventional msg3 transmission may not be interpreted at the small cell. Msg3 may be replaced by a new MAC control element.

Once the RAR may be received from the target SCeNB, the UE may send the RRC Connection reconfiguration complete to macro the eNB. Macro eNB may also wait for an indication from SCeNB when the UE may successfully complete uplink synchronization as specified herein.

A PDCP status report may then be exchanged between peer PDCP entities (e.g. in the UE and in target SCeNB), perhaps followed by data transmission.

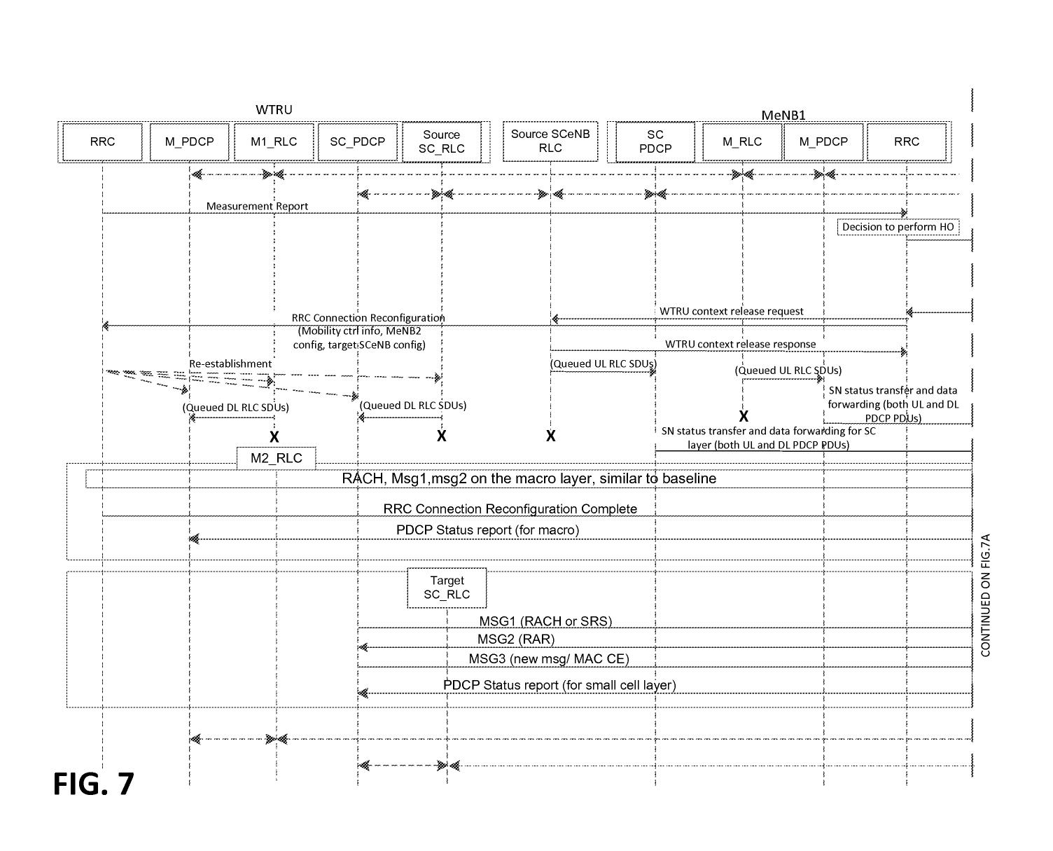

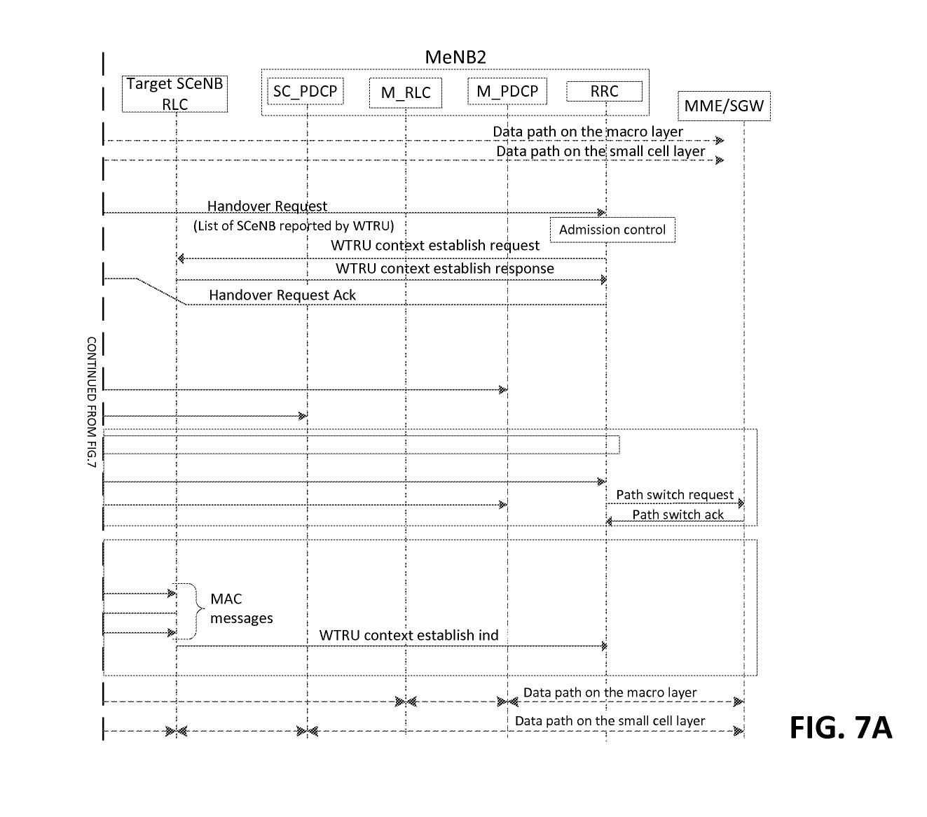

One or more embodiments contemplate a reconfiguration of the macro cell layer, such as the example of FIG. 7 and FIG. 7A. Some embodiments contemplate a scenario where a macro eNB may be changed during handover. In addition to that there may be one or more variations, perhaps in some embodiments depending on the small cell layer change:

a) MeNB1=>MeNB2 (baseline LTE Rel8/10 handover)
This may be the 3GPP baseline scenario a where small-cell layer may not be involved and the UE may move from source macro-cell (MeNB1) to the target macro-cell (MeNB2);

b) MeNB1=>MeNB2+SCeNB1 (Macro cell change+ Small cell addition)
In such scenarios, a new small-cell may be added to the UE configuration in addition to the Macro-cell change from source macro-cell (MeNB1) to the target macro-cell (MeNB2); and/or

c) MeNB1+SCeNB1=>MeNB2+SCeNB2 (Macro cell change+ Small cell change)
In such scenarios, the UE may move from source small-cell (SCeNB1) to target small-cell (SCeNB2), in addition to the Macro-cell change from source macro-cell (MeNB1) to the target macro-cell (MeNB2)

d) MeNB1+SCeNB1=>MeNB2 (Macro cell change+ Small cell deletion)
In such scenarios, the small-cell may be removed/deleted from the UE configuration in addition to the Macro-cell change from source macro-cell (MeNB1) to the target macro-cell (MeNB2).

The aforementioned scenarios a-d may be employed individually and/or in any combination, in whole and/or in part.

FIG. 7 and FIG. 7A depict an example handover scenario involving both macro and small cell layer change specifically covering scenario (c) above, but also at least implicitly scenarios (b) and (d) as well.

Referring to FIG. 7 and FIG. 7A, a Macro eNB may configure the measurement parameters/events/triggers for the UE in RRC CONNECTED mode. In some embodiments, there may be different configurations for macro and small cell layer.

A UE may send the measurement report perhaps when the configured reporting criterion may be satisfied. In the example, it could be as an event representing the MeNB1 RSRP/RSRQ below the configured threshold and/or the MeNB2 RSRSP/RSRQ above the configured threshold. In addition to that, UE could also report the list of SCeNBs on the small cell layer. In one example, the list of SCeNB measured could be limited to the list of SCeNBs currently served by the MeNB2. This could be signaled as measurement re-configuration from the MeNB1, for example, after MeNB2 may exceed a configured threshold.

In some embodiments, different outcomes may be possible depending on the scenarios. In one or more embodiments the macro eNB may perform one or more of the following:

a) the scenarios may become macro to macro handover, perhaps for example perhaps if the UE had a MeNB1 connection (or perhaps only a MeNB1 connection) and if it either,
> reports macro MeNB2 with no other SCeNBs, (or)
> reports macro MeNB2 with at least one SCeNB, but UE could not be admitted to the SCeNB;

b) the scenarios may become a macro cell change with small cell addition, for example perhaps if the UE had a MeNB1 connection (or perhaps only a MeNB1 connection) and if it reports macro MeNB2 with at least one SCeNBs;

c) the scenarios may become macro cell change with small cell deletion, for example perhaps if the UE had dual connectivity on MeNB1+SCeNB1 and if it either
> reports macro MeNB2 with no other SCeNBs, (or)
> reports macro MeNB2 with at least one SCeNB, but UE could not be admitted to the SCeNB; and/or

d) the scenarios may become macro cell change with small cell change, for example perhaps if the UE had dual connectivity on MeNB1+SCeNB1 and if it reports macro MeNB2 with at least one SCeNBs.

In some embodiments, the RRC connection reconfiguration message may trigger different types of macro reconfiguration behavior.

In some embodiments, a Handover from MeNB1 to MeNB2 may be same as baseline LTE Rel8/10 hand over. In some embodiments, a Handover from MeNB1 to MeNB2 with the addition of one or more small cell eNBs may be performed by including the mobilityctrl info and/or the radioresourceconfig dedicated info on the macro layer. New configuration for small cell layer may be added by providing the group/node index as described herein. The new small cell configuration may include the SCell and/or the radio bearer configuration on the small cell layer, for example.

In some embodiments, perhaps in case of handover from MeNB1 with small cell layer to a new MeNB2 may be performed by adding mobility ctrl info and the dedicated radio resource config for the macro layer and the group/node index release for the corresponding small cell layer. In case of both macro and small cell change, a combination of small cell deletion (e.g. for the source small cell) and small cell addition (for the target small cell) may be performed.

In some embodiments, the handover with both macro cell change and small cell change could be done either in sequence or parallel. In some embodiments, the handover method may be signaled in the handover command from the macro eNB. In other words the handover command may specify whether handover can be sequential or parallel, it could also specify whether the handovers may use combined RACH and/or direct access and/or separate RACH.

In some embodiments, in a sequential approach, first the uplink sync and access may be performed on the macro layer and/or after the handover may be completed successfully on the macro layer, macro may provide the UE with the SCeNB configuration. Handover may then be performed over the small cell layer. This approach may reduce the handover preparation time as the small cell layers may not be configured during the preparation phase.

In some embodiments, a handover can be performed simultaneously on a macro and a small cell layer. The contemplated RACH procedures to support sequential and parallel handover are described herein.

In some embodiments, a Macro eNB may wait for the handovers in a macro and/or a small cell layers to complete before triggering the path switch request to MME. In some embodiments, when the PDCP terminates in a macro, a macro eNB may also trigger a path switch when the handover is completed on the macro layer, while the handover in the small cell may still be ongoing.

One or more embodiments contemplate a small-cell shared across multiple macro-eNBs. Embodiments contemplate one or more scenarios where the small-cell may be shared across multiple macro eNBs. The potential deployment scenarios where this architecture may be utilized include, but not limited to one or more of:

Small-cell layer infrastructure may be deployed by a 3rd party (e.g. such as Boingo) and/or shared among multiple mobile network operators

Small-cell layer infrastructure shared among multiple mobile network operators who may already have MOUs for network sharing

Dense urban deployments, where a particular small-cell may be shared by multiple macro eNBs to alleviate or minimize data-loss during handover

mmW hotspot scenarios, where small-cell boundaries may not be as clearly defined as those in lower frequencies.

The impact on handover procedures including both network and UE related aspects may be described herein when a UE moves from source macro-cell (MeNB1) to a target macro-cell (MeNB2) while still being attached to the same small-cell (SCeNB1) that may be shared across a source and a target macro-cells.

Some embodiments contemplate one or more handover procedures. For example, in or more embodiments, a handover may include one or more of the following:
Macro eNB may configure the measurement parameters/events/triggers for the UE in an RRC CONNECTED mode. In some embodiments, there could be different configurations between macro and small cell layer;
UE may send the measurement report when the configured reporting criterion may be satisfied. For example, it could be an event representing the MeNB1 RSRP/RSRQ below the configured threshold and/or the MeNB2 RSRSP/RSRQ above the configured threshold. In addition to that, the UE could also report the list of SCeNBs on the small cell layer;
Handover from MeNB1 to MeNB2 may involve changes to the handover request and/or handover ack messages between the macro-cells on the X2 interface. This may now include the current small-cell(s) info that the UE may currently be connected to and what radio bearers may be serviced by these corresponding small-cell(s). When MeNB2 recognizes that one or more of these small-cells may be shared, it may indicate to MeNB1 that it may not release (or in some embodiments perhaps should not release) the corresponding data plane layers (and any associated control-plane aspects at the small-cells) at these small-cells;
The small-cells that may be shared may be indicated (or may need to be indicated) over the backhaul interface that any GTP tunnels that may be established for data forwarding from the MeNB1 for this UE may be updated (or perhaps may need to be updated) to move them to MeNB2;
The handover message to the UE may indicate not to reconfigure or reestablish the data-plane layers associated with DRBs (data RBs) corresponding to these small-cells that are being shared. These could be performed by including the mobilityctrl info and/or the radioresourceconfig dedicated info on the macro layer. New configuration for macro-layer may be provided as in the 3GPP baseline message;
If PDCP may be terminated in the macro-cell, then the existing baseline procedures may apply for forwarding of PDCP data from MeNB1 to MeNB2 even for DRBs that may correspond to the small-cells that may be shared between the source and/or target macro-cells. All the lower-layers for data-plane may not be reconfigured (or might not need to be reconfigured) during this handover event, leading to a handover interruption time for the bearers associated with shared small-cells. Also there may be no impact to PDCP reordering and security/ciphering procedures; and/or
If a PDCP may be terminated at the small-cell, then there may be no impact at the UE because of the RBs that may be mapped to the small-cells that may be shared. The security keys may have to updated based on the security scenario used as described herein.

One or more embodiments contemplate a PDCP Re-Ordering. In some embodiments, perhaps in case of a PDCP in the macro cell, a PDCP re-ordering may be performed during a handover (PDCP re-establishment). In case of an intra-eNB inter-SCeNB handover, the PDCP entity (for DRBs mapped to AM RLC) at the macro may maintain its state variables like COUNT etc. When a handover may be triggered, for the uplink transmission, the source RLC (in source SCeNB) may forward the queued UL RLC SDUs (e.g. potentially out-of-order) to macro PDCP. Macro may buffer these PDCP PDUs, perhaps until it may receive in order transmission from the UE in the target SCeNB. Macro PDCP also prepares a PDCP status report that may reflect the up-to-date status of the PDCP receiver in the macro. This PDCP status report may then be sent using the target RLC (e.g. in target SCeNB). UE may receive this PDCP status report and may start transmitting from the first missing UL PDCP PDU.

In some embodiments, for the DL transmission, UE RLC may forward the buffered DL RLC SDUs to the UE PDCP. UE PDCP may buffer them until it may receive the transmission from target SCeNB. UE may also prepare a PDCP status report to be sent on the target SCeNB after handover. This PDCP status report may be transparently forwarded by target SCeNB to macro PDCP. This may help macro PDCP forward PDCP PDUs from the first missing SN. Embodiments contemplate that the source and target SCeNB may have an X2 interface between them. Source SCeNB could forward the RLC SDUs which are not transmitted and/or not yet ACKed to the target SCeNB. Target SCeNB can either inspect the status report from the UE and/or wait for indication from the macro PDCP to transmit a first downlink RLC SDU after handover.

In some embodiments, perhaps in a case of a PDCP in macro (single DRB), the following sequence may be specified to support reconfiguration:

### UE PDCP RECEIVER OPERATION:

Normal case: re-ordering algorithm:
0) Receive the PDCP data PDU from lower layers
1) Let the next in-sequence PDU SN be N.
2) If it is duplicate or PDU out of re-ordering window. Discard the packet and go to line 0.
3) If received PDCP Data PDU SN=N goto line 7.
4) If re-ordering timer is not running, start the PDCP re-ordering timer as soon as out of sequence PDCP Data PDU SN>N (from say RLC1/RLC2) is received.
5) When the re-ordering timer is running, if PDCP Data PDU (from say RLC2/RLC1 respectively) is received with SN>N, then

a. If the remaining re-ordering time is greater than threshold, trigger a PDCP status report and wait for in-sequence PDCP PDU with SN=N. goto line 0.

b. Stop re-ordering timer and perform same actions as re-ordering timer expiry.

6) If the re-ordering timer expires goto 7.
7) Deliver the queued packets to the higher layer, starting from closest received SN to N in order until the next SN gap and, for example, perhaps if there is any SN gap, start re-ordering timer similar to line 4.
8) Set N=1+SN of PDCP data PDU last delivered to higher layer in line 7.
9) Goto line 0.

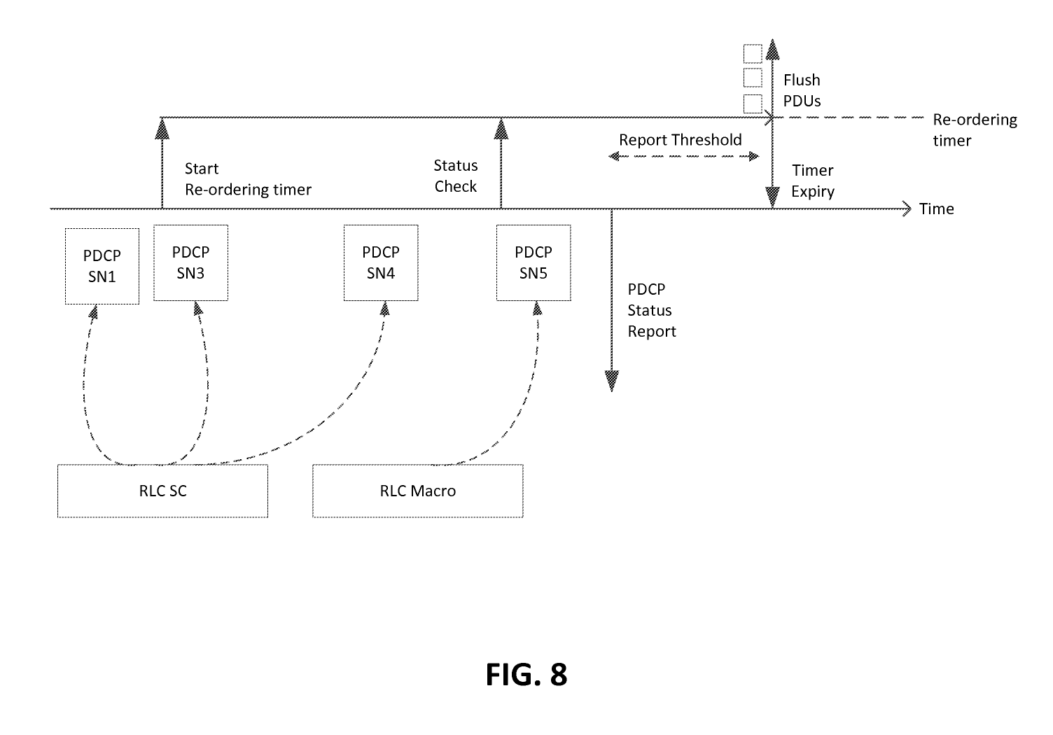

FIG. 8 illustrates an example representation of the aforementioned sequence that captures the triggers for status check and the actions related to reordering timer. One or more embodiments contemplate techniques for PDCP re-ordering that may include starting a reordering timer, for example perhaps when an out of sequence packet may be received from any one of RLC entities. Techniques may also include marking the missing sequence number. A status check procedure may be performed, for example perhaps when a new (e.g. fresh or updated) packet may be received from another RLC entity. The status check may include matching the marked sequence number with sequence number in the new packet, perhaps in some embodiments when the new packet sequence may be greater than the marked sequence number. A PDCP status report may be transmitted, for example to trigger retransmission, perhaps in some embodiments if the time to expiry for the reordering timer may be more than a configured report threshold. One or more, or all, queued PDUs and/or advancing the PDCP receive window and/or canceling the re-ordering timer may be done, for example perhaps if the time to expiry for the reordering timer may be less than a configured report threshold.

One or more embodiments contemplate a handover between SCeNBs with same Macro anchor, that may include a re-ordering algorithm. When re-establishment may be triggered the pico RLC may be reset (or in some embodiments perhaps only such a RLC), but the macro RLC may continue its session. So pico RLC may deliver the queued SDUs to the PDCP receiver entity. The re-ordering time may be re-started and the PDCP receiver may then send a status report to convey missing PDUs. A PDCP transmitter can then forward the missing PDUs using macro RLC, while the target pico RLC may be setup in the UE. A first PDU re-transmitted from macro PDCP after receiving a status report from the UE, may be marked with a bit in the PDCP header, so that the UE may not wait (or perhaps may not need to wait) for lost PDUs during handover. After this, normal functions may be restored as described herein.

One or more embodiments contemplate a PDCP Discard.

Since the PDCP in the macro and RLC in the SCeNB may not be co-located, the standard PDCP discard mechanism might result in excessive signaling across X2′ interface. The signaling overhead between macro and SCeNB interface can be reduced with one or more contemplated mechanisms.

In some embodiments, RLC SDU or set of RLC SDUs sent from macro to pico may also have some control information associated with it. In addition to UE mapping and/or QoS related information, the control info may also include time to live info for this RLC SDU. This time to live may be calculated as follows:

Time to live=PDCP discard timer−time spent by this PDU in PDCP buffer.

In some embodiments, the PDCP discard can be a local RLC operation and signaling may be avoided to achieve this functionality, among other techniques. Also the RLC in the SCeNB can also have its own AQM, and the ‘Time to live’ can be one of the inputs for efficient operation of AQM.

One or more embodiments contemplate Security. RRC and UP keys may be refreshed at handover. KeNB* may be derived by UE and source eNB from target PCI, target frequency and KeNB (this may be referred to as a horizontal key derivation and may be indicated to UE with an NCC that may not increase) or from a target PCI, target frequency and NH (this may be referred to as a vertical key derivation and is indicated to UE with an NCC increase). KeNB* may then be used as new KeNB for RRC and UP traffic at the target. When the UE goes into ECM-IDLE one or more, or all keys may be deleted from the eNB.

COUNT reusing avoidance for the same radio bearer identity in RRC_CONNECTED mode without KeNB change may be left to eNB implementation, e.g. by using intra-cell handover, smart management of radio bearer identities and/or triggering a transition to RRC_IDLE.

In case of PDCP in the macro, the same KUPenc and KRRCenc/KRRCint may be used for one or more, or all, traffic, perhaps since the ciphering and integrity protection operations may be performed in the Macro.

In case of PDCP in the small cell, when a radio bearer or some portion of a radio bearer may be moved from one small cell to another, the user plane key may (or in some embodiments perhaps should) be re-generated.

Some embodiments contemplate maintaining one key for macro+ all SCeNBs. Some embodiments contemplate generating separate user-plane keys for the individual radio bearers transferred on handing over a radio bearer from one small cell to another small cell node.

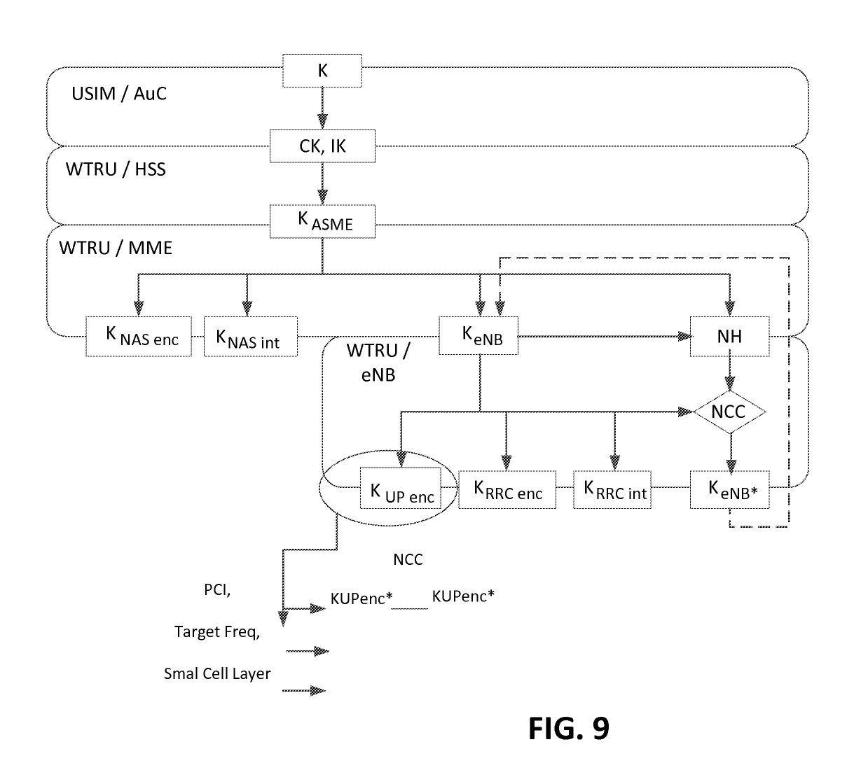

In some embodiments, the KUPenc could be re-generated when a data flow/radio bearer may be moved from one eNodeB to another eNodeB, using PCI, target frequency, layer indicator which may capture if the target may be a small cell or a macro, and other parameters. Separately, horizontal key generation may be performed to increment count when the UE may moves one or more, or each, time into a single small cell node. KUPenc* perhaps then the new user-plane key, may be used for user-plane traffic to/from the small cell node. FIG. 9 illustrates an example security key generation technique contemplate by embodiments.

In one or more embodiments, the PDCP security keys may be configured with the SCell configuration which may include the SCeNB index. In some embodiments, the MME may configure the eNB with a preconfigured vector of one or more, or all, the NH values that may be used by the eNB in subsequent activation of the Scell for different SCeNBs.

In one or more embodiments, the NCC index to SCeNB index mapping may be pre-configured for security, perhaps so the UE may use the NCC index to generate KeNB when the first Scell may be in the SCeNB. The UE may generate the keys, perhaps when the Scell may be configured or activated. One or more, or all, the subsequent Scell in the same SCeNB may use the same security context. Alternatively or additionally, NCC may be sent in the MAC CE Activation command, for example.

In one or more embodiments, the UE may maintain a counter with the NCC count, and perhaps when the UE may get an Activation command for first SCell in SCeNB, it may increment the NCC counter to generate a new (e.g., fresh) KeNB with the new (e.g., fresh) value of NCC. Perhaps when subsequent activations may be performed on the same SCeNB, the UE may continue to use the existing keys.

In one or more embodiments, the UE may use a fixed configured NCC for one or more, or all, the SCells in the small cell layer, that may be configured by the Macro in the RRC signaling (e.g. configuration, Security Mode Command, etc.). One or more subsequent activations and/or deactivations, or perhaps every subsequent activation and/or deactivation, in the small cell layer could use horizontal key derivation to generate a new security keys, for example.

In one or more embodiments, the UE may use a fixed configured NCC for one or more, or all the SCells for a SCeNB (and in some embodiments perhaps for a single SCeNB), that may be configured by the Macro in the RRC signaling (e.g. configuration, Security Mode Command, etc.). One or more, or every, subsequent activation and/or deactivation of the SCells in the same SCeNB could use horizontal key derivation to generate a new security keys, for example.

In one or more embodiments, perhaps when the UE may get an activation command, the UE may generate one or more new (e.g., fresh) keys and/or get prepared to use the pre-configured keys. The UE may send an indication back to the SCeNB, perhaps when it may be ready to receive data using the new (e.g., fresh) security keys. The indication may be sent via MAC and/or RRC signaling. For example, the indication could be sent to the SCeNB via MAC CE and/or sent to the SCeNB or the Macro using RRC signaling. Also by way of example, the indication may be sent on Msg3. The Msg3 may carry an indication, either MAC and/or RRC, that may indicate that the UE has completed the security key generation. In some embodiments, the indication may be sent using RRC signaling, such that the RRC message that may be sent may be integrity protected and/or ciphered, perhaps with keys generated per security configuration for the small cell. The SCeNB may send a response after confirming the UE's keys may be correct, perhaps after verifying the integrity of Msg3 in a new (e.g., fresh or heretofore undefined) RRC message (e.g., Msg4).

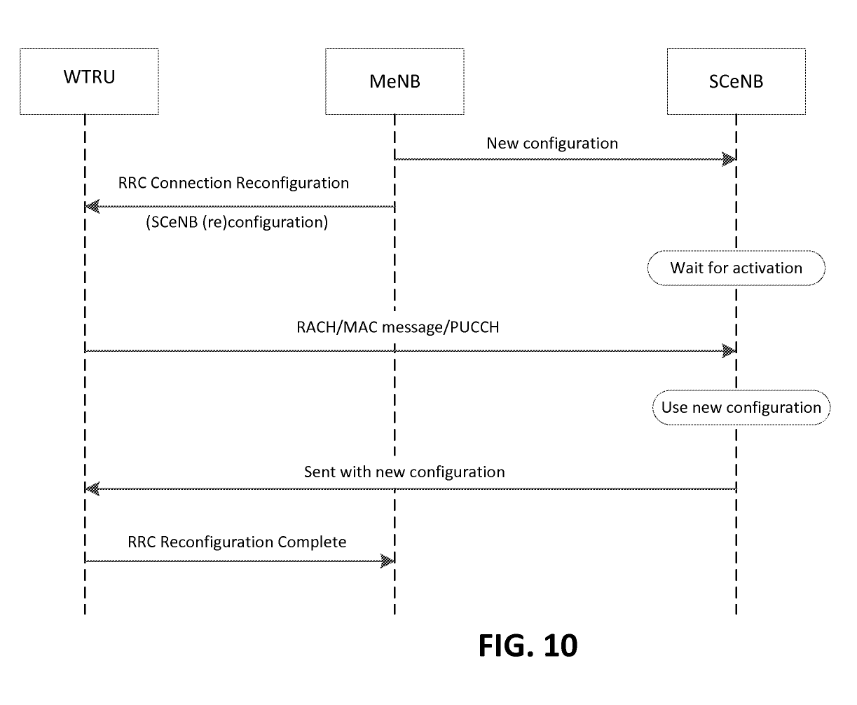

In one or more embodiments, perhaps upon receiving the indication, the SCeNB may proceed to send encrypted user plane data to the UE, perhaps using the new (e.g., updated) security context. In some embodiments, a UE may indicate its readiness to receive from the SCeNB for any new (e.g., updated) RRC reconfiguration using RACH/MAC CE/PUCCH signaling. An example technique is illustrated in FIG. 10. One or more embodiments contemplate that a UE may receive a RRC reconfiguration from a macro site that may contain the new (e.g. fresh) RRC configuration to use in the small cell. The RRC configuration may also include an UL indication resource for small-cell. MAC and/or PHY layers corresponding to small cell may be configured with the new configuration. An indication to the small cell may be transmitted, for example using the preconfigured UL resource (e.g. via RACH, MAC message, and/or PUCCH). The UE may receive data from the small cell with the new configuration. The UE may transmit a RRC reconfiguration complete indication to the macro site.

In one or more embodiments, a small cell may receive a UE specific radio bearer configuration for the small cell operation from the macro eNB. The small cell may receive an indication from the UE (e.g., via RACH, MAC message, and/or PUCCH) to activate the aforementioned configuration. The small cell may activate the configuration provided by the macro eNB.

In one or more embodiments, the lifetime of the key or keys may be an activation sequence (e.g., a single activation sequence) and/or a configuration sequence (e.g., a single configuration sequence), for example.

In one or more embodiments, perhaps during mobility, the source eNB and/or the MME may additionally indicate the list of NCCs and/or NH values that may already be used by the target eNB in the source, and/or give a new (e.g., fresh) set of NH values to the target eNB that may be used for small cell SCells.

One or more embodiments contemplate one or more mobility measurements. The Macro eNB may configure a new measurement configuration for the small cell eNB when the small cell may be added. The macro's measurement configuration MeasConfig could include new threshold for S-meas, to define when the UE may (or perhaps should) initiate mobility measurements for the small layer. In addition, perhaps based on scheduling, the macro could configure the UE to start/stop the measurements of the small cell layer.

Embodiments contemplate a measurement reporting procedure, perhaps for when the UE may be requested to report the small cell measurements with different configuration, periodicity, events and thresholds as compared to reporting for the macro layer. The macro may use the measurements of the small cell layer to make handover decision, for e.g., even if the UE may have a better link to a particular macro eNB1, if the connection to small eNB associated with macro eNB2 and/or better, and/or the UE is handed over to the macro eNB2.

In some embodiments, the UE may indicate a preference to a certain neighbor based on the small cell measurements, or proximity with small cells detected by other means. For e.g., if the UE may be configured with location or PCIs of small cell nodes, the proximity detection at the UE could be a trigger to send a new measurement report or indication to the network to request reconfiguration.

In one or more embodiments, perhaps in order to handle Layer 2 mobility in one layer (e.g., small cell layer), a mobility management entity in another layer (e.g., macro) may find useful assistance from the UE and/or the SCeNB.

The UE may send an indication to the Macro, perhaps when it may detect its radio link degradation on the small-cell layer. The degradation may be detected by one or more configured Layer 1, Layer 2, and/or Layer 3 events. In one or more embodiments, perhaps when the UE may detect its radio link conditions may have fallen below a configured threshold in the small-cell layer, the UE may send a measurement report to the MeNB on another layer. For example, if the CQI may be less than a configured threshold, the UE may be triggered to send an indication to the network.

In one or more embodiments, the trigger to send the indication may be sent by the small cell eNB (SCeNB), for example, by use of a MAC CE. In some embodiments, perhaps when the SCeNB may detect the UE CQI measurement may have fallen below a threshold, the SCeNB may send a trigger to the UE RRC to send an aperiodic RRC measurement report to the MeNB on another layer (for example, the Macro). In some embodiments, the SCeNB may directly and/or indirectly send an indication over the backhaul to the Macro and/or forward the measurement report from the UE to the Macro. In one or more embodiments, the indication sent to the Macro layer could be a measurement report, for example an aperiodic small cell CQI report and/or an aperiodic RRC measurement report.

In one or more embodiments, the RRC measurement report may include one or more measurements of neighbor cells on the small cell layer, and/or a set of configured neighbor cells, and/or one or more, or all, cells in a cluster. In some embodiments, the measurement report could be configured to include one or more, or all, cells that may be part of the cluster, and/or a white list of neighbors that may be configured in the measurement object.

In one or more embodiments, the UE may be configured with a cluster identity such that the UE may trigger a measurement report for one or more measurement objects, perhaps as a function of such configuration. For example, if the CQI may be less than a configured threshold, the SCeNB and/or the UE itself may trigger to send a RRC measurement report.

One or more embodiments contemplate that it may be useful for the activation of one cell to trigger a relatively faster measurement cycle for neighboring cells. For example, the measurement configuration may include a list of white listed cells that may be neighbor cells for the configured small-cell. Perhaps when the small-cell may be activated, one or more of the neighbor cells may stop using measCycleSCell (e.g., a measurement cycle for Scells in deactivated state), and/or may use a different (e.g., relatively faster) measurement cycle. In some embodiments, the activation of at least one cell may trigger a scaling down of the measCycleSCell to a smaller value, for example. Perhaps when at least one cell may be activated in at least one layer (e.g., the small cell layer), this may trigger a measurement report (e.g., a CSI-RS report) for one or more white list neighbor cells that may be sent to a node in another layer (e.g. the Macro layer).

In one or more embodiments, the SCeNB may send a command to the UE to request a aperiodic CQI measurement report to the MeNB (e.g., over RRC), perhaps for example, when the SCeNB may detect a degradation of one or more uplink channel conditions.

One or more embodiments contemplate one or more Idle Mode Selection/Re-selection Procedures. In a deployment with small cells, it may be useful for the UEs to preferentially camp to the macros that have optimum small cell coverage. In one example, the UE may have best macro coverage from macro eNB1 but under small cell coverage of small cell SCeNB2 tethered to macro eNB2. In this case, it would be optimum for the UE to selection macro eNB2 as the suitable cell, so that it may have better access to small cell layer when it moves to connected mode.

In some embodiments, the UE may measure one or more, or all, the cells in the neighborhood, and may make a list of the top N strongest cells. If any of the cells may be macro cells that have with small cells which may also be in the list, then the corresponding macro cell may be prioritized for cell selection. In some embodiments, the small cells may broadcast separate discovery reference signals that the UE may monitor and for the cell selection. The UE may consider the macros in the list that advertise the presence of one of the detected small cells (or in some embodiments perhaps only such macros). In some embodiments, the macro eNB may provide the small cells that it may be managing in the SIB1.

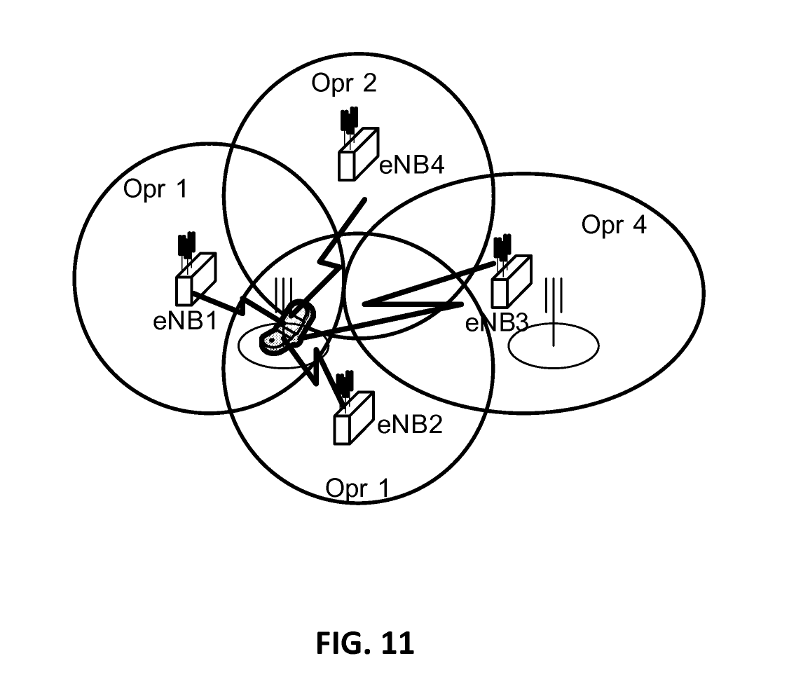

Referring to FIG. 11, in some embodiments, the small cell node may be shared by multiple operators—Opr 1 and Opr 3, and may send a list of macro network/operators it may be associated with, perhaps assuming the UE may belong to Operator 1. FIG. 11 illustrates an example small cell shared by multiple operators. The UE may perform cell selection decisions using the macro layer and small cell layer in at least two stages—the UE may detect the small cell layer and may detect the strongest signal from the small cell layer—the UE may detect the small cell layer information indicating it supports Operator 1, Macro eNB2. Based on strongest signal from the macro layers, the UE may start with Macro eNB 1 and may use the small cell list to determine that it may not be associated with the strongest small cell. The small cell layer support may be for Macro eNB 2, and the UE may then select Macro eNB2.

In some embodiments, the Srxlev may be calculated using the proximity (rx_pwr) from the small cell as one of the parameters in the calculation. In some embodiments, the detection of small cell could be factored by addition of a new term Qsmallcelloffset which may be computed as the delta=(Qrxlevmeas(small_cell)−Qrxlevmeas(macro)). Additionally the UE may have a separate power class for the small cell, and the computation may also account for Pcompensation (small cell).

One or more embodiments contemplate one or more random access procedures for small cell layer. Some embodiments contemplate a combined RACH for macro and small cell. During inter-macro eNB handovers, the target macro eNB can configure the associated small cells (could be one or more, or all, the small cells or a subset of them, may determine the factors like, which source eNB requests handover, measurement results provided by the UE via source cell and/or approximate location information of the UE, or the like) the RACH configuration used by the UE. When UE performs random access to the target macro eNB, the configured small cells can also listen to this uplink transmission of the UE and may estimate among other factors at least the timing, preamble and/or UL signal level (above a local threshold).

Small cells may then provide this information (which may include detected UE preambles, and/or timing advance, etc.) to the macro eNB. Macro eNB can use suitable criteria to filter out the candidate small cells and may provide chosen candidates and their configurations (along with timing advance to the small cell, locations of reference signals, etc.) to the UE. Macro eNB may also provide the temporary CRNTI that may be allocated by the small cell and frame offset of allocation start. The UE may then perform DL timing synchronization to the small cell and may use the provided timing advance for uplink access on small cell. This may expedite the UE access to the small cell perhaps without the need to have separate random access procedure.

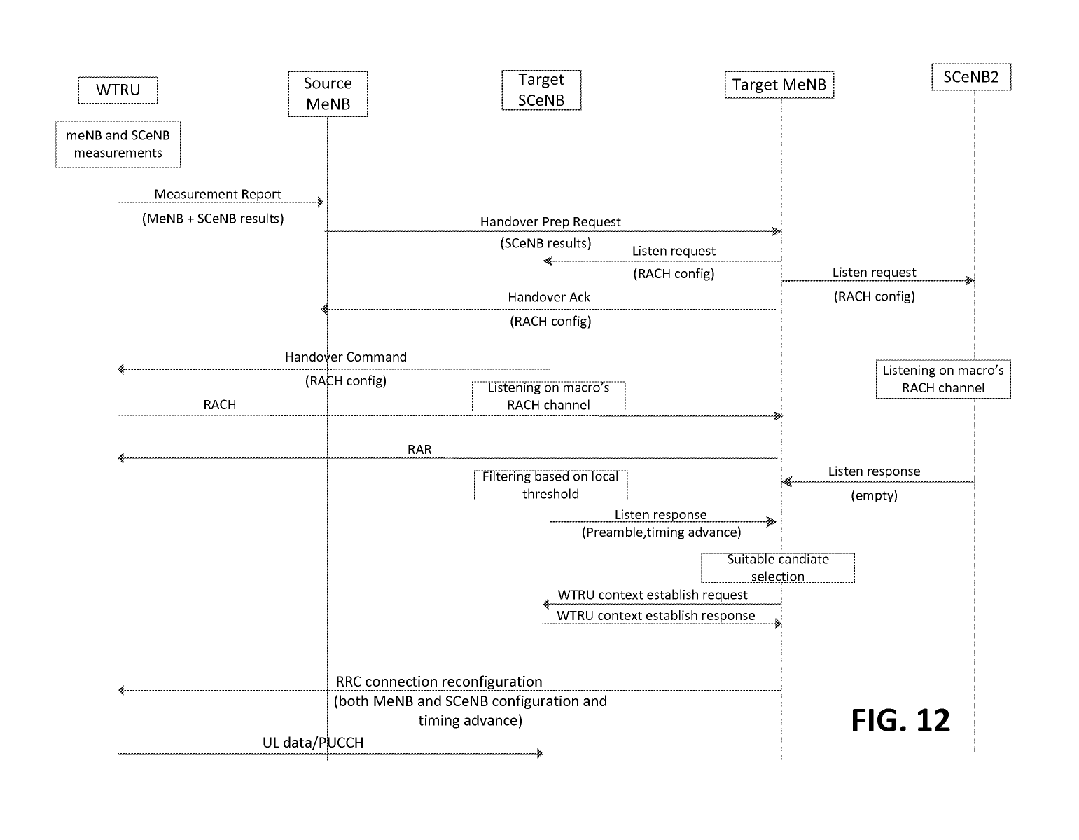

In some embodiments, the aforementioned technique can also be extended to the small cell addition scenario. For example, small cell layer can use the uplink transmissions made by UE to macro eNB to estimate UE's suitability and/or timing advance and can provide this information to macro eNB. Macro can then configure the UE to measure the downlink transmissions from the small cell (e.g. by providing locations of new reference signals or using the existing reference signals from the small cell). Macro can also provide the propagation delay estimated by the small cell to the UE, so that UE can access the small cell without having the need to perform random access procedure. In some embodiments, the small cell addition scenario may use UE's SR/SRS transmissions, perhaps instead of RACH. An example signaling flow for a combined RACH procedure is shown in FIG. 12.

Referring to FIG. 12, one or more embodiments contemplate that a Macro eNB may receive a handover request from a source macro eNB. The Macro eNB may configure one or more small cells with a UE specific RACH configuration, which may be used to perform RACH listen procedure. The Macro eNB may send to a source macro eNB a handover acknowledgement (ack) message, that may include a common RACH configuration applicable to the macro layer and/or small cell layer. The Macro eNB may obtain results of RACH listen procedure that may include timing advance, UL signal level, and/or RACH preamble information from one more small cells. A short listing (e.g. identification or determination) of one or more small cells may be done, perhaps based on the received RACH results from the small cells. The Macro eNB may configure the short-listed small cells to service the UE involved in RACH procedure. The Macro eNB may receive UL/DL allocation information for the UE from the small cell eNB. The Macro eNB may configure the UE with small cell configuration information that may include the timing advance and/or resource allocation to the small cells. The Macro eNB may receive the configuration activation confirmation from the UE and/or the selected small cell(s).

One or more embodiments contemplate that a Small cell eNB may calculate the timing advance, for example perhaps using the common RACH configuration and/or the RACH listen procedure. The Small cell eNB may receive a handover request from the Macro eNB. The Small cell eNB may allocate UL and/or DL resources to the UE for a duration that may be equal to a response window. The Small cell eNB may provide the UE resource allocation information to the Macro eNB, perhaps along with and/or in addition to a handover Ack message.

One or more embodiments contemplate that the UE may receive an RRC reconfiguration with small cell addition, that may include a timing advance to be applied to the small cell, radio bearer configuration for the small cell, offset to the sub frame containing resource allocation, and/or a response window. The UE might not perform a Random access procedure to the small cell. In some embodiments, this may be referred to as small cell direct access. Embodiments recognize that a random access procedure may be used for one or more purposes (e.g., resolve contention, obtain UL timing advance, obtain initial UL transmission power, etc.). In some embodiments there might not be an issue of contention, perhaps since the small cell addition may be controlled by macro eNB. In some embodiments, a small cell eNB may be based on a RACH listen procedure and/or any other mechanism that may estimate the UL timing advance and/or the initial UL power level for the UE (e.g. where small cell sizes are small). In some embodiments, the small cell eNB may directly configure a DL and/or UL resource to the UE as described previously. In such scenarios, among others, the UE might not perform full-fledged RACH. The UE may receive and/or decode a PDCCH message, for example perhaps according to the configured resource. In some embodiments, the UE may transmit to the small cell, a PUCCH/MAC message, for example perhaps according to the configured resource with the provided timing advance.

One or more embodiments contemplate that a Source Macro eNB may obtain measurement results for the macro layer. The Source Macro eNB may configure a UE with measurements on the macro layer (e.g., that may include one or more, or all, the frequencies that may be used by the Macro eNBs). The Source macro eNB may obtain measurement results for the macro layer from the UE. The Source Macro eNB may place on a “shortlist” (e.g. identify) potential small cells (e.g., those small cells that may be associated to corresponding macro cells ranked based on the measurement results), for example perhaps depending on the macro layer results. The Source Macro eNB may configure the UE to measure those small cells (for example, perhaps by including the carrier frequencies that may be used by the small cell eNBs and/or their cell IDs).

The Source Macro eNB may trigger the UE to measure one or more small cells that may be associated to the target macro eNB. The Source Macro eNB may receive measurement results of one or more small cells, for example perhaps according to the configured measurement events. The Source Macro eNB may provide an indication on the X2 interface, the target macro, the set of Small cells measured by the UE, and/or the set of bearers mapped to one or more, or each, of the small cells. The Source Macro eNB may receive from the target macro eNB an indication to retain one or more bearers on the small cell layer and one or more bearers that may be moved from the source macro eNB and/or source small cell, perhaps after a handover on the macro layer. For example, the UE may have bearers b1, b2 from Source MeNB and/or bearers b3, b4 from small cell eNB. The Source Macro eNB may determine a handover may be useful and/or may make one or more requests regarding the Target MeNB. In some embodiments, it may be assumed that the same small cell eNB may be shared between source MeNB and Target MeNB). The Target eNB may map none, one or more, or all, of {b1,b2,b3,b4} to Target MeNB. The Target MeNB may add none, one or more, or all of {b1,b2} (e.g., which might not already be chosen by target MeNB) to small cell eNB. The Target eNB may remove none, one or more, or all, of {b3,b4} (e.g., which may already be chosen by the Target MeNB) from the small cell eNB. The Target MeNB may send such a decision(s) to the Source Macro eNB. The Source Macro eNB may perform the bearer move and/or deletion operation. The Source Macro eNB may send a handover command to the UE. The Source Macro eNB may release bearers on one or more small cell eNB, perhaps as indicated by the Target Macro eNB.

One or more embodiments contemplate a small cell RACH. In some embodiments, the RRC may terminate at the macro eNB and DRBs may be carried by small cells (perhaps only DRBs). In such architecture, one or more, or all, the RRC messages may be transmitted to macro eNB. RACH procedures may be modified to support such architecture.

In case of contention free random access, the configuration of small cell parameters (e.g. dedicated RACH preamble, PRACH resource, etc.) may be provided by macro eNB to the UE. The difference from baseline random access procedure may be that RRC and MAC may terminate at different nodes. The UE may send RRC configuration complete to macro eNB, while RACH preambles may be sent to small cell eNB. In some embodiments, this may affect the timing and triggers to send RRC configuration complete. RRC configuration complete may be sent to macro eNB after receiving RAR from the small cell eNB. Also from the small cell point of view, handover completion may be detected by new msg3, as perhaps using RRC message in this architecture may not be possible, as small cell may not interpret RRC messages. This new msg3 can be any higher layer packet (data/PDCP status report), which may or may not include BSR (e.g. for the case where the buffers of radio bearers handed over to small cell may be empty, BSR may be sent, and in some embodiments perhaps may always be sent). In addition, the first uplink transmission to the small cell eNB may have a new MAC CE with a unique UE identity. In some embodiments, the msg3 can include a new MAC CE with the CRNTI of the macro eNB. If the small cell may be shared with multiple macro eNB, then a combination of CRNTI+ cell id of macro can be used. If the small cell may be shared among multiple operators then CRNTI+ global cell id of macro can be used. In some embodiments, the unique UE ID may also be derived from STMSI. In msg4 the small cell eNB may echo back the contents of msg3 to the UE.

In case of contention based random access, parallel handovers may be performed in macro and/or small cell layers. Small cell layer may have a contention resolution procedure different from macro eNB. Similar to the contention based random access, a new msg3 may be used to indicate completion of handover and/or to resolve contention. The UE ID in msg3 may be chosen as a function/combination of at least one of CRNTI/Cell-id/Global cell-id/STMSI. The small cell eNB may then send msg4 with the same unique UE ID received in msg3.

The small cell RACH procedure may co-exist with an ongoing macro random access procedure (e.g. for parallel handover scenario) and/or can be a sequential procedure that may be triggered after a successful macro handover.

In some embodiments, UE may be handed over to multiple small cells and/or added to multiple small cells. In this case, with UE may be required to perform one RACH transmission (and perhaps only one) for one or more, or all, the configured small cells. One or more, or all, the configured small cells may receive the preamble and may estimate the timing advance and may provide the grants and timing advance command individual RAR per small cell layer.

One or more embodiments contemplate small cell direct access. For small cells with very small radius, the propagation delays may not be significant. Embodiments contemplate that the conventional random access may be replaced with a direct access. Direct access may allow the UE to make the uplink transmission in the cell based on the small cell DL frame timing and offset factor provided by the macro. Macro eNB may calculate this offset by the knowledge of timing advance on the macro cell and the relative position of the small cell and the UE.

In some embodiments the UE may get allocations on the target small cell immediately after the handover command may be received from the macro eNB, for example perhaps when small cell addition/small cell handover may be triggered by the macro eNB. In some embodiments, this target resource allocation may be conveyed by the small cell to the macro eNB and then to the UE via handover command. This handover command may then include the allocation start offset (e.g. with reference to small cell frame number), a new IE in the RRC message identifying the PUCCH resource/SRS to use in the target small cell and the duration (in subframes) of this allocation which may corresponds to the response_window_size. If no uplink transmissions may be received during this duration then handover failure procedures may be triggered. This PUCCH allocation may re-use existing PUCCH formats (e.g. convey dummy ACK or CQI) and/or a new PUCCH format just to convey for example the ID of the UE (e.g. which may be provided over the handover command, e.g. Temp-CRNTI obtained from small cell via macro eNB in handover command) and/or a predefined SRS configuration if SRS resource may be used.

In some embodiments, a direct access using PDSCH may be performed. For this, small cell may send the temporary CRNTI (or perhaps only the temporary CRNTI) to the macro eNB and this may be forwarded along with small cell config to the UE. The UE may then read target small cell PDCCH using the temporary CRNTI received in the handover command from the macro eNB to find the UL allocations. These allocations may be of smaller size (½ RBs) and may last for a specific number of sub frames (e.g. either persistently allocated or individually allocated) defined by response_window_size. If no uplink transmissions may be received during this duration then handover failure procedures may be triggered. UE ID may be implicitly known by the fact that allocations may be made specific to UE and any uplink transmission in the allocated resources may be assumed to be sufficient to detect the UE.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A first wireless transmit/receive unit (WTRU), the first WTRU being in communication with a network, the first WTRU comprising:
a processor, the processor configured to at least:
receive a second radio resource control (RRC) configuration corresponding to a second WTRU, the second RRC configuration being a replacement to a previously received first RRC configuration;
receive an uplink (UL) indication resource corresponding to the second WTRU, the UL indication resource including dedicated information for communication with the second WTRU, the second WTRU being in communication with the network, the second WTRU configured to recognize the UL indication resource, the second WTRU being a small cell enhanced Node-B (SCeNB);
configure a medium access control (MAC) layer with the second RRC
configuration, the MAC layer configured to recognize the second WTRU; and
initiate the transmission of a first indication to the second WTRU using the UL indication resource, the first indication causing the second WTRU to activate a configuration corresponding to the second RRC configuration.

2. The first WTRU of claim 1, wherein the processor is further configured to:
receive data from the second WTRU using the second RRC configuration; and
initiate the transmission of a second indication to a third WTRU, the second indication indicating that the second RRC configuration is completed.

3. The first WTRU of claim 1, wherein the processor is further configured such that the second RRC configuration is received from a third WTRU, the third WTRU being in communication with the network.

4. The first WTRU of claim 1, wherein the processor is further configured to configure a physical (PHY) layer with the second RRC configuration, the PHY layer corresponding to the second WTRU.

5. The first WTRU of claim 2, wherein the processor is further configured such that the transmission of the indication to the second WTRU using the UL indication resource is conducted via at least one of a random access channel (RACH), a MAC message, or a physical uplink control channel (PUCCH).

6. The first WTRU of claim 1, wherein the second RRC configuration includes a reconfiguration of the second WTRU.

7. (canceled)

8. The first WTRU of claim 2, wherein the third WTRU is a macro enhanced Node-B (MeNB).

9. A first wireless transmit/receive unit (WTRU) in communication with a communication network, first WTRU being a small cell enhanced Node-B (SCeNB), the first WTRU comprising:
a processor, the processor configured, at least to:
receive a first configuration for the first WTRU, the first configuration corresponding to a second WTRU, the first configuration including instructions to recognize an uplink (UL) indication resource, the UL indication resource including dedicated information for communication with the first WTRU;
receive an indication from the second WTRU, the indication including the UL indication resource, and the indication causing the first WTRU to activate the first configuration; and
activate the first configuration upon receipt of the indication.

10. The first WTRU of claim 9, wherein the processor is configured such that the indication is received via at least one of a random access channel (RACH), a MAC message, or a physical uplink control channel (PUCCH).

11. The first WTRU of claim 9, wherein the processor is further configured to:
initiate the transmission of data to the second WTRU using the first configuration.

12. The first WTRU of claim 9, wherein the processor is configured such that the first configuration is received from a third WTRU.

13. The WTRU of claim 9, wherein the first configuration includes a radio bearer configuration corresponding to the second WTRU.

14. (canceled)

15. The first WTRU of claim 12, wherein the third WTRU is a macro enhanced Node-B (MeNB).

16. A wireless transmit/receive entity (WTRU), the WTRU in communication with a network and one or more radio link control (RLC) entities, the WTRU comprising:
a processor, configured at least to:
receive a first packet of one or more packets from a first radio link control (RLC) entity of the one or more (RLC) entities;
determine that the first packet is an out-of-sequence packet;
start a timer upon determining that the first packet is an out-of-sequence packet;
determine at least one missing sequence number;
receive a second packet of the one or more packets from a second RLC entity of the one or more RLC entities;
perform a packet sequence status check upon receipt of the second packet; and
transmit a packet data convergence protocol (PDCP) status report upon a time to expiry for the timer being more than a configured threshold, the PDCP status report triggering a retransmission of the one or more packets.

17. The WTRU of claim 16, wherein the processor is further configured such that the packet sequence status check comprises:
determine a sequence number associated with the second packet; and
match the at least one missing sequence number with the sequence number associated with the second packet upon the sequence number associated with the second packet sequence being greater than the at least one missing sequence number.

18. (canceled)

19. The WTRU of claim 16, wherein the processor is further configured to:
flush one or more queued packet data units (PDUs) upon the time to expiry for the timer being less than the configured threshold.

20. The WTRU of claim 16, wherein the processor is further configured to:
advance a PDCP receive window upon the time to expiry for the timer being less than the configured threshold.

21. The WTRU of claim 16, wherein the processor is further configured to:
at least one of: stop or restart the timer upon the time to expiry for the timer being less than the configured threshold.

22. The WTRU of claim 16, wherein the timer is a reordering timer.

23. The WTRU of claim 16, wherein WTRU is a first WTRU and the first RLC entity corresponds to at least one of: a second WTRU or a third WTRU.

24. The WTRU of claim 16, wherein WTRU is a first WTRU and the second RLC entity corresponds to at least one of: a second WTRU or a third WTRU.

25. The WTRU of claim 23, wherein the second WTRU is a small cell enhanced Node-B (SCeNB).

26. The WTRU of claim 23, wherein the third WTRU is a macro enhanced Node-B (MeNB).

27.-40. (canceled)
